(19) United States
(12) Patent Application Publication
(10) Pub. No.: US 2013/0083554 A1
(43) Pub. Date: Apr. 4, 2013

(54) LIGHTING DEVICES AND METHODS FOR PROVIDING COLLIMATED DAYLIGHT AND AUXILIARY LIGHT

(71) Applicant: Paul August Jaster, Carlsbad, CA (US)

(72) Inventor: Paul August Jaster, Carlsbad, CA (US)

(21) Appl. No.: 13/250,951

(22) Filed: Sep. 30, 2011

(51) Int. Cl. F21V 7/04; B23P 11/00

(52) U.S. Cl. 362/555; 362/558; 29/428

(57) ABSTRACT

Lighting devices and methods for providing collimated daylight and auxiliary light are disclosed. Some embodiments disclosed herein provide a daylighting apparatus including a tube having a sidewall with a reflective interior surface, one or more auxiliary light sources, and a collimator. In some embodiments, the tube is disposed between a transparent cover positioned to receive daylight and a diffuser positioned inside a target area of a building. In certain embodiments, the tube is configured to direct at least a portion of the daylight transmitted through the transparent cover and/or at least a portion of generated auxiliary light towards the collimator and the diffuser.

### BACKGROUND

1. Field

This disclosure relates generally to daylighting systems and methods and, more particularly, to daylighting systems and methods involving light control and/or light generation capabilities.

2. Description of Related Art

Daylighting systems typically include windows, openings, and/or surfaces that provide natural light to the interior of a structure. Examples of daylighting systems include skylight and tubular daylighting device (TDD) installations. In a TDD installation, a transparent cover can be mounted on a roof of a building or in another suitable location. An internally reflective tube can connect the cover to a diffuser mounted in a room or area to be illuminated. The diffuser can be installed in the ceiling of the room or in another suitable location. Natural light entering the cover on the roof can propagate through the tube and reach the diffuser, which disperses the natural light into the interior of the structure.

### SUMMARY

Some embodiments disclosed herein include lighting devices and methods that provide collimated daylight and auxiliary light. In some embodiments, a tube is disposed between a transparent cover positioned to receive daylight and a diffuser positioned inside a target area of a building. In certain embodiments, the tube is configured to direct at least a portion of the daylight transmitted through the transparent cover towards the diffuser. The auxiliary lighting system can include a light source and a light control surface configured to reflect at least a portion of the light exiting the light source towards the diffuser and to transmit at least a portion of the daylight propagating through the tube from the direction of the transparent cover. In some embodiments, the collimator apparatus is configured to provide increased alignment of both daylight and auxiliary light before the light propagates to the diffuser, as compared to a device without such a collimator.

In some embodiments, a daylighting apparatus is configured to provide natural light to the interior of a building. The apparatus can include a tube having a sidewall with a reflective interior surface. The tube can be configured to receive daylight through a transparent cover disposed near a top region of the tube and to direct the daylight towards a bottom region of the tube opposite the top region of the tube. A diffuser can be configured to be positioned inside of the building and configured to receive the daylight directed towards the bottom region of the tube. An auxiliary lighting system can include a light source configured to provide illumination to at least a portion of the interior of the daylighting apparatus, the light source positioned such that light that is emitted by the light source propagates such that the at least a portion of the light is incident on a surface other than the diffuser before propagating to the diffuser. The apparatus can include a light-aligning apparatus having one or more wall segments with an exterior surface and a reflective interior surface configured to receive at least a portion of the light propagating through the tube and to turn the at least a portion of the light in order to increase an included angle between the path of propagation of the at least a portion of the light and a reference plane generally or substantially parallel to a base of the diffuser. In some embodiments, the light-aligning apparatus has a top edge disposed substantially near the bottom end of the tube and a base edge disposed farther away from the tube than the top edge, wherein a width of the light-aligning apparatus at its top edge is greater than or equal to a width of the tube at the bottom end of the tube.

In some embodiments, at least a portion of the auxiliary lighting system is connected to the sidewall of the tube. In certain embodiments, at least a portion of the auxiliary lighting system is connected to or at least disposed within the light-aligning apparatus. The auxiliary lighting system can include multiple light sources. In some embodiments, the light sources can be arranged along a generally planar section of the tube or along a generally planar section of the light-aligning apparatus. In some embodiments, at least one of the light sources can be connected to the sidewall of the tube and at least one of the light sources can be connected to at least one of the one or more wall segments of the light-aligning apparatus. Light sources can be light-emitting diodes or any other suitable lamp.

A light control surface can be positioned in proximity to one or more light sources and configured to reflect at least a portion of the light from the light source towards the diffuser. The one or more wall segments can include a plurality of wall segments configured to form a collimator with at least one collimating angle. The plurality of wall segments can be configured to form a collimator with two or more collimating angles.

The tube of the daylighting device can include a first segment and a second segment, wherein the first and second segments are removably connected to each other.

In some embodiments, greater than or equal to about 50% or greater than or equal to about 65% of the light emitted by the auxiliary lighting system exits the daylighting apparatus through the diffuser.

In certain embodiments, the exterior surface of the light-aligning apparatus is shielded or blocked from and not exposed to light propagating within the daylighting apparatus. The base edge of the light-aligning apparatus can be disposed above the diffuser. The top edge of the light-aligning apparatus can be disposed below the base edge of the tube. The light-aligning apparatus can have a width located at a longitudinal center of the light-aligning apparatus that is greater than the width of the tube at its base edge. The top edge of the light-aligning apparatus can be joined to the base edge of the tube. A cross-sectional shape of the light-aligning apparatus at its top edge can be substantially the same as a cross-sectional shape of the tube at its base edge.

In some embodiments, a method of providing light to an interior of a building includes permitting daylight to pass from a transparent cover through a tube to a diffuser inside of the building, emitting artificial light from an auxiliary light source into an interior region of the tube, and collimating, with a light-aligning apparatus, at least a portion of the daylight and at least a portion of the artificial light simultaneously. A width of the light-aligning apparatus at a top edge or region of the light-aligning apparatus can be greater than or equal to a width of the tube at a bottom region or end of the tube.

Certain embodiments provide a method of manufacturing a daylighting apparatus. The method can include connecting a transparent cover configured to receive daylight to a top edge or region of a tube having a sidewall with a reflective interior surface, connecting a top edge or region of a light-aligning apparatus having an exterior surface and a reflective interior surface to a base edge or region of the tube, wherein the base edge or region of the tube is disposed farther away from the transparent cover than the top edge or region of the tube, connecting a diffuser to a base edge or region of the light-aligning apparatus, wherein the base edge or region of the light-aligning apparatus is located farther away from the base edge or region of the tube than the top edge or region of the light-aligning apparatus, and fixing an auxiliary lighting system comprising a light source to the daylighting apparatus, the light source configured to provide illumination to at least a portion of the interior of the daylighting apparatus by emitting a generally conical emission of light such that at least a portion of the light emitted by the auxiliary lighting system is incident on a surface other than the diffuser before propagating to the diffuser. The light-aligning apparatus can be configured to reflect light propagating through the tube that is incident on the interior surface of the light-aligning apparatus, thereby increasing an included angle between the path of propagation of the reflected light and a reference plane generally or substantially parallel to a base of the diffuser lies. A width of the light aligning apparatus at its top edge or region can be greater than or equal to a width of the tube at its base edge or region.

Some embodiments provide a method of manufacturing a daylighting apparatus. The method can include providing a tube having a sidewall with a reflective interior surface, providing a transparent cover configured to receive daylight and to be connected to a top edge or region of the tube, providing a light-aligning apparatus having a reflective interior surface and a top edge or region configured to be connected to a base edge or region of the tube, wherein the base edge or region of the tube is disposed farther away from the transparent cover than the top edge or region of the tube, providing a diffuser configured to be connected to the light-aligning apparatus, and providing an auxiliary lighting system comprising a light source configured to be fixed to the daylighting apparatus, the light source further configured to provide illumination to at least a portion of the interior of the daylighting apparatus by emitting a generally conical emission of light such that at least a portion of the light emitted by the auxiliary lighting system is incident on a surface other than the diffuser before propagating to the diffuser. The light-aligning apparatus can be configured to reflect light propagating through the tube that is incident on the interior surface of the light-aligning apparatus, thereby increasing an included angle between the path of propagation of the reflected light and a reference plane parallel to a base of the diffuser. The top edge or region of the light-aligning apparatus can be disposed substantially near the base edge or region of the tube, wherein a width of the light-aligning apparatus at its top edge or region is greater than or equal to a width of the tube at its base edge or region.

### BRIEF DESCRIPTION OF THE DRAWINGS

Various embodiments are depicted in the accompanying drawings for illustrative purposes, and should in no way be interpreted as limiting the scope of the inventions. In addition, various features of different disclosed embodiments can be combined to form additional embodiments, which are part of this disclosure. Any feature or structure can be removed or omitted. Throughout the drawings, reference numbers may be reused to indicate correspondence between reference elements.

FIG. 1 is a block diagram representing an embodiment of a daylighting device.

FIG. 2 is a cross-sectional view of an embodiment of a daylighting device.

FIG. 3 is a cross-sectional view of an embodiment of a daylighting device comprising an auxiliary light source.

FIG. 4 is a cross-sectional view of an embodiment of a daylighting device comprising an LED light source.

FIG. 5 is a cross-sectional view of an embodiment of a daylighting device.

FIG. 6 is a perspective view of an embodiment of a tube with a light control surface attached thereto.

FIG. 7 is a perspective view of an embodiment of an auxiliary lighting fixture connected to a tube.

FIG. 8 is a cross-sectional view of the auxiliary lighting fixture shown in FIG. 7.

FIG. 9 is a partial cross-sectional view of the prismatic film of the auxiliary lighting fixture shown in FIG. 8.

FIG. 10 is another partial cross-sectional view of the prismatic film of the auxiliary lighting fixture shown in FIG. 8.

FIG. 11 is a cross-sectional view of embodiments of prismatic films having different diameters.

FIG. 12 is a sample graph showing an example of a relationship between the diameter of a prismatic film and the proportion of auxiliary light that travels up the tube.

FIG. 13 is a cross-sectional view of an embodiment of an auxiliary lighting fixture connected to a tube.

FIG. 14 is a top view of an embodiment of an unbent light control surface

FIG. 15 is a cross-sectional view of an embodiment of a daylighting device.

FIG. 16 is a side view of an embodiment of an auxiliary light source connected to a lighting fixture.

FIG. 17 is a cross-sectional view of an embodiment of a daylighting device.

FIG. 18 is a cross-sectional view of an embodiment of an auxiliary lighting fixture connected to a daylighting device.

FIG. 19 is a perspective view of an embodiment of a light control surface.

FIG. 20 is a cross-sectional view of an embodiment of a daylighting device.

FIG. 21 is a cross-sectional view of an embodiment of a daylighting device.

FIG. 22 is a cross-sectional view of an embodiment of a light guide.

FIG. 23 is a cross-sectional view of an embodiment of a light-aligning structure.

FIG. 24 is a cross-sectional view of an embodiment of a light-aligning structure.

FIG. 25 is a perspective view of an embodiment of a light-aligning structure.

FIG. 26 is a side view of an embodiment of a light-aligning structure.

FIG. 27 is an overhead view of an embodiment of a light-aligning structure.

FIG. 28 is a cross-sectional view of an embodiment of a daylighting device.

### DETAILED DESCRIPTION OF PREFERRED EMBODIMENTS

Although certain preferred embodiments and examples are disclosed herein, inventive subject matter extends beyond the examples in the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in a manner or order that may be helpful in understanding certain embodiments; however, the order of description should not be construed to imply that these operations are order-dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

In some embodiments, tubular daylighting devices can include a transparent dome enclosure configured to be positioned on the roof of a building structure, a generally vertical reflective tube extending from the dome enclosure, and a diffuser disposed at the opposite end or region of the reflective tube. The dome allows exterior light, such as natural light, to enter the system. The tube transfers the exterior light down to the diffuser, which disperses the light generally throughout a targeted room or area in the interior of a building.

A daylighting device can include an optical collimator configured to turn light propagating through the daylighting device such that, when light (such as, for example, daylight, auxiliary light, or daylight and auxiliary light) exits the daylighting device and/or enters a diffuser, the light has increased alignment, as compared to a device without a collimator. In some embodiments, a substantial portion of light propagating through a daylighting device may propagate within the daylighting device at relatively low angles of elevation from a horizontal plane of reference. Such angles of propagation may, in some situations, cause the light to have undesirable properties when it exits the daylighting device. For example, the optical efficiency of a diffuser substantially positioned within a horizontal plane can be substantially reduced when light is incident on the diffuser at low angles of elevation from the horizontal plane. As another example, light that is incident on the diffuser at low angles of elevation can result in light exiting the daylighting device at an exit angle of greater than or equal to about 45 degrees from vertical. Light exiting a daylighting device at those angles can create glare and visibility issues in the area or room being illuminated.

A collimator apparatus can be configured such that light that would otherwise enter the diffuser at undesirable angles is turned to a more desirable angle. For example, the collimator or light aligning apparatus can ensure that light passing through the daylighting device will exit the daylighting device at an exit angle of less than or equal to about 45 degrees from vertical, or at a substantially or nearly vertical orientation, when the diffuser is horizontal. In some embodiments, the collimator or light aligning apparatus can ensure that light passing through the daylighting device will exit the daylighting device at an exit angle of less than or equal to about 45 degrees from a longitudinal axis of the daylighting device or a portion of the daylighting device, or at an orientation substantially or nearly parallel to the longitudinal axis of the daylighting device or a portion of the daylighting device. In certain embodiments, the collimator apparatus is configured to reduce or prevent the light from exiting the daylighting device at an angle of between about 45 degrees and about 60 degrees from vertical. In this manner, the collimator apparatus can reduce or eliminate the glare and visibility issues that light exiting a lighting fixture between those angles can cause.

The daylighting device can include an auxiliary lighting system. For example, the auxiliary lighting system can be inserted into the tube to provide light from the tube to a target area or room when sunlight is not available in sufficient quantity to provide a desired level of interior lighting. In some embodiments, tubular daylighting devices in which the lighting fixture is suspended from a rod or wire may suffer from various drawbacks. For example, the rod, or other apparatus for supporting the lamp, and the lamp itself may occupy a substantial portion of the tube interior, thereby reducing the performance of the tubular daylighting device. If a lighting apparatus is attached to a fixture such as a rod or wire in the center of the tube, and especially if the lighting apparatus has a heat exchanger attached to its back side, a large amount of daylight can be blocked from continuing down the tube.

In some cases, a conventional lighting apparatus typically illuminates in a pattern that allows nearly half of the generated light to be lost back up the tube. Moreover, in some cases, only a portion of the light from the lamp enters the tube base diffuser at an incident angle that provides high transmission efficiencies. When the incident angle of light on the diffuser is high, a greater portion of light can be reflected back up the tube by the diffuser. This effect, together with the light lost up the tube due to the illumination pattern of the lamp, can result in a substantial portion of light from the lamp not reaching the targeted area. Also, in some cases, if the lighting apparatus is facing towards the diffuser, it can create a very bright spot of light that may require further diffusion to eliminate glare and reduce contrast.

Some daylighting devices and methods can incorporate an auxiliary lighting system that is connected to, or used in connection with, a collimator to achieve desirable illumination properties. In some embodiments, the collimator is configured to increase the collimation of both natural light and light emanating from one or more auxiliary light sources. Certain embodiments are configured to provide a desirable distribution and level of illumination within a target area or room under a wide range of natural light conditions. Examples of providing a desirable distribution and level of illumination include providing a substantially even distribution of interior light using any combination of natural light and artificial light, providing a substantially steady level of illumination during daytime or nighttime, providing a distribution of interior light that does not change substantially between daytime and nighttime, providing at least a threshold level of illumination, or any combination of such features. In some embodiments, a daylighting device is configured to provide greater than or equal to about 400 lumens, greater than or equal to about 450 lumens, greater than or equal to about 500 lumens, greater than or equal to about 1000 lumens, greater than or equal to about 2000 lumens, greater than or equal to about 3000 lumens, or another suitable level of illumination during daytime or nighttime. In certain embodiments, a daylighting device is configured to provide direct illumination of surfaces substantially throughout a room of greater than or equal to about 1 lumen, 2 lumens, 3 lumens, 4 lumens, or 5 lumens per square foot, between about 1 lumen and about 15 lumens per square foot, between about 1 lumen and about 10 lumens per square foot, between about 3 lumens and about 10 lumens per square foot, or within another suitable range. In some embodiments, a daylighting device is configured to provide illumination such that the difference between the greatest level of illumination and the least level of illumination of surfaces that receive direct illumination from the daylighting device is less than or equal to a threshold level. In certain embodiments, the threshold level of differing illumination level for directly illuminated surfaces is about 5 lumens, 4 lumens, 3 lumens, 2 lumens, or 1 lumen per square foot.

The term “collimator” is used herein according to its broad and ordinary sense, and includes, for example, light-aligning structures having one or more sidewalls with a reflective interior surface configured such that the exit angle of the light reflected by the collimator is closer to parallel to a longitudinal axis of the tube (e.g., closer to vertical) than the entrance angle of the light. In some embodiments, a collimator increases the elevation angle from a reference plane perpendicular to a longitudinal axis of the tube (e.g., from horizontal) of at least a portion of the light propagating through the daylighting device such that the at least a portion of the light exits the daylighting device at a more vertical angle. The degree to which the light is turned can depend on the orientation and position of the portion of the one or more reflective interior surfaces on which the light is incident.

Some embodiments disclosed herein provide a daylighting apparatus including a tube having a sidewall with a reflective interior surface, a collimating structure, and an auxiliary light fixture. The tube can be disposed between a transparent cover positioned to receive daylight and a diffuser positioned inside a target area of a structure such as a building. In certain embodiments, the tube is configured to direct the daylight transmitted through the transparent cover towards the diffuser. The auxiliary light fixture can include a lamp disposed within the tube and a light control surface configured to reflect light exiting the lamp towards the diffuser and to transmit daylight propagating through the tube from the direction of the transparent cover. The lamp can be disposed on the interior sidewall of the tube or otherwise positioned in a way that permits light generated by the lamp to pass into the interior of the tube.

As used herein, “tube” is used in its broad and ordinary sense. For example, a tube includes any conduit, channel, duct, guide, chamber, pipe, pathway or passageway, regardless of cross-sectional shape or configuration, and such terms may be used interchangeably, where appropriate. For example, a tube may be generally cylindrical in shape, or may have a rectangular, oval, triangular, circular, or other cross-sectional shape or combination of cross-sectional shapes. Furthermore, references to tubes or tubular structures may refer to structures having any suitable length, width or height.

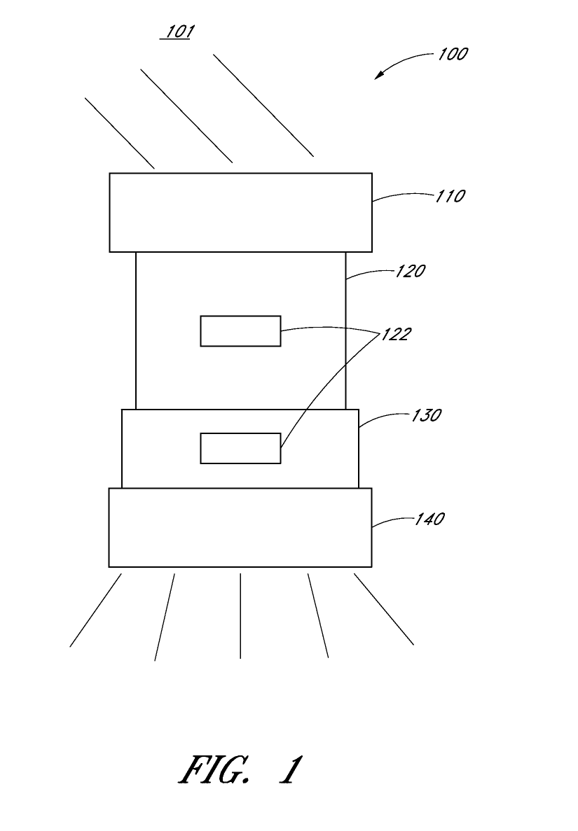

FIG. 1 depicts a block diagram representing an embodiment of a daylighting device 100. The daylighting device 100 includes a light-collecting unit 110 which is exposed, either directly or indirectly to a source of light, such as, for example, the Sun. Light enters the light-collecting unit and propagates into a tube 120. The tube 120 provides a channel, or pathway, between the light-collecting unit 110 and a light-aligning apparatus 130. The interior surface of the tube 120 is reflective. In some embodiments, at least a portion of the interior surface of the tube 120 is specular.

When the daylighting device 100 is installed, the tube 120 is physically connected to, or disposed in proximity to, the light-aligning apparatus 130, which is configured to collimate light exiting the light-aligning apparatus 130. In some embodiments, light exiting the light-aligning apparatus propagates along a path that is substantially or nearly perpendicular to a plane in which the diffuser 140 lies. In certain embodiments, light exiting the light-aligning apparatus propagates along a path that is substantially or nearly perpendicular to a plane perpendicular to an elongate axis of the daylighing system 100.

In certain embodiments, the daylighting device 100 includes an auxiliary lighting system 122. The auxiliary lighting system 122 emits light that propagates through at least a portion of the daylighting device 100. In the illustrated embodiment, the auxiliary lighting system 122 includes light sources at two different regions within the daylighting device 100. In other embodiments, the auxiliary lighting system 122 can include a single light source, multiple light sources in the same region, a single light source in different regions, or multiple light sources in different regions. For example, the auxiliary lighting system 122 can be contained within, or disposed in proximity to, the light-aligning apparatus 130. In certain embodiments, the auxiliary lighting system 122 is contained within, or in proximity to, the tube 120, or within, or in proximity to, another portion of the daylighting device 100. In some embodiments, more than one auxiliary light source may be disposed within, or in proximity to, the daylighting device 100. In embodiments configured such that daylight 101 enters the collector unit 110 and is dispersed by the diffuser 140, the auxiliary lighting system 122 may be used to supplement or replace the daylight when the level of available daylight is insufficient to produce a desired amount of illumination in the area or room.

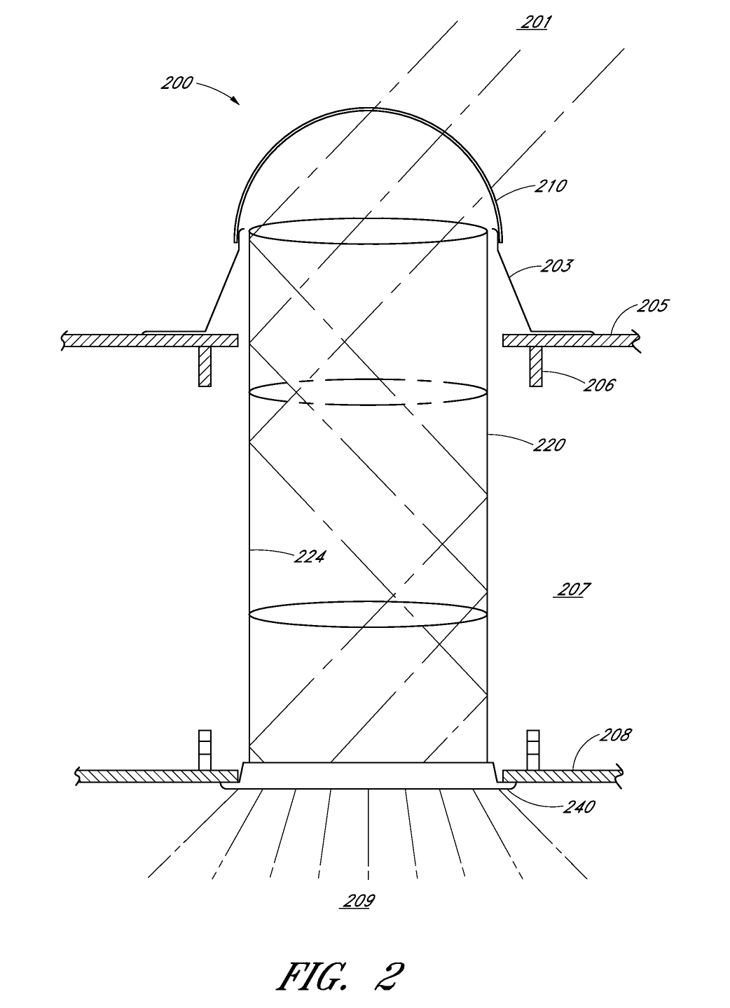

FIG. 2 illustrates a tubular daylighting device that directs daylight from the roof or exterior of a structure 205 to the interior of the structure 209 via a tube 220 with a reflective surface 224 on the tube interior. In certain embodiments, the interior surface is specular. The embodiment depicted in FIG. 2 includes a transparent or partially transparent cover 210 on the exterior of the structure through which daylight may enter the tube. The transparent dome 210 can beneficially prevent outside environmental debris from entering the tube. A diffuser 240 at the base of the tube 220 can be configured to spread the light exiting the tube inside the interior of the structure.

The tubular daylighting device 200 illustrated in FIG. 2 may be installed in a building for illuminating, at least partially with natural light, an interior room 209 of the building. The transparent cover 210 may be mounted on a roof 205 of the building. The cover 210 serves to collect light from an external source, such as natural light, and allows such light to enter a tube 220, or conduit. The cover 210 can be mounted to the roof 205 using a flashing 203. The flashing 203 can include a flange that is attached to the roof 205 and/or a curb that is angled as appropriate for the cant of the roof 205 to engage and hold the cover 210 in a generally vertically upright orientation.

The tube or conduit 220 can be connected to the flashing 203 and can extend from the roof 205 through a ceiling 208 of the interior room 209. The tube 220 can direct light that enters the tube 220 downwardly to a light diffuser 240, which disperses the light in the interior room 209. At least a portion of the inside surface of the tube 220 can be reflective, facilitating propagation of light that is incident on the sidewall 224 of the tube 220. The tube 220 can be made of any suitable material, either rigid or flexible, such as metal, fiber, plastic, an alloy, or a combination of materials. For example, at least a portion of the tube 220 can be constructed from type 1150 alloy aluminum.

The tube 220 can terminate or be connected or in light communication with at a light diffuser 240. The light diffuser 240 can include one or more devices or structures that spread out, disperse, or scatter light in a suitable manner. In some embodiments, the diffuser 240 absorbs relatively little or no visible light and transmits most or all incident visible light, at least at certain angles of incidence. The diffuser 240 can include one or more lenses, ground glass, holographic diffusers, or any other suitable diffusers. The diffuser 240 can be connected to the tube 220 using any suitable connection technique. For example, a seal ring can be surroundingly engaged with the tube 220 and connected to the light diffuser 240 to hold the diffuser 240 onto the end of the tube 24.

FIG. 3 illustrates a daylighting device 300 incorporating an auxiliary light source 322. The light source may be any type of light source, including, but not limited to incandescent bulb, compact fluorescent bulb, LED, etc. In the embodiment depicted in FIG. 3, the light source 322 is a bulb suspended inside a tube 320 of the daylighting device 300. The light source 322 is connected to a power source, such as, for example, a battery, or to the power supply of a structure via a power cord 323 or other electrical connection. An auxiliary light source such as that depicted in FIG. 3 may be desirable as a source of light in situations where insufficient natural light is available for channeling through the daylighting device 300. The luminaire configuration of FIG. 3 may emit light such that a portion of the light emanating from the light bulb 322 propagates up the tube 320 and out through a cover 310, and the rest propagates down the tube and out of the tube 320 into an interior room 309 of the structure via a diffuser.

Table A shows test data relating to performance and efficiency of light transmission in daylighting devices incorporating various light bulbs in configurations similar to that of the embodiment shown in FIG. 3:

TABLE A

| | Source | Tested | System |
|---|---|---|---|
| | Rated | Performance | Efficacy |
| Light Source | Lumens | (Lumens) | (Tested/Source) |
| 95 watt incandescent | 1,550 lumens | 531 lumens | 34% |
| bulb | | | |
| 27 watt compact | 1,400 lumens | 547 lumens | 39% |
| fluorescent bulb | | | |

The “Tested Performance” identified in Table A corresponds to a measurement of light transmitted through a diffuser and received externally, such as in an interior room adjacent the diffuser. The relatively low efficiency is due to, among other things, light lost up the tube 320, as described above. Furthermore, diffusers typically transmit light through a limited range of incident angles. Therefore, optical losses through the diffuser at the base of the tube also affect the efficiency of the system. In addition to the above issues, the structure of the light source (e.g., the light fixture, or support structure) blocks natural light coming down the tube 320 and reduces the efficiency of the daylighting device 300 when natural light is available. Table B shows results from a test comparing the performance of a daylighting device with respect to natural light transmission with and without a light fixture installed:

TABLE B

| Sunlight | Sunlight | PerCent Blockage |
|---|---|---|
| Performance With | Performance Without | of Sunlight @ |
| a Fluorescent | a Fluorescent | Solar Altitude |
| Bulb Fixture | Bulb Fixture | of 50 Degrees |
| 1,480 lumens | 1,639 lumens | 10% |

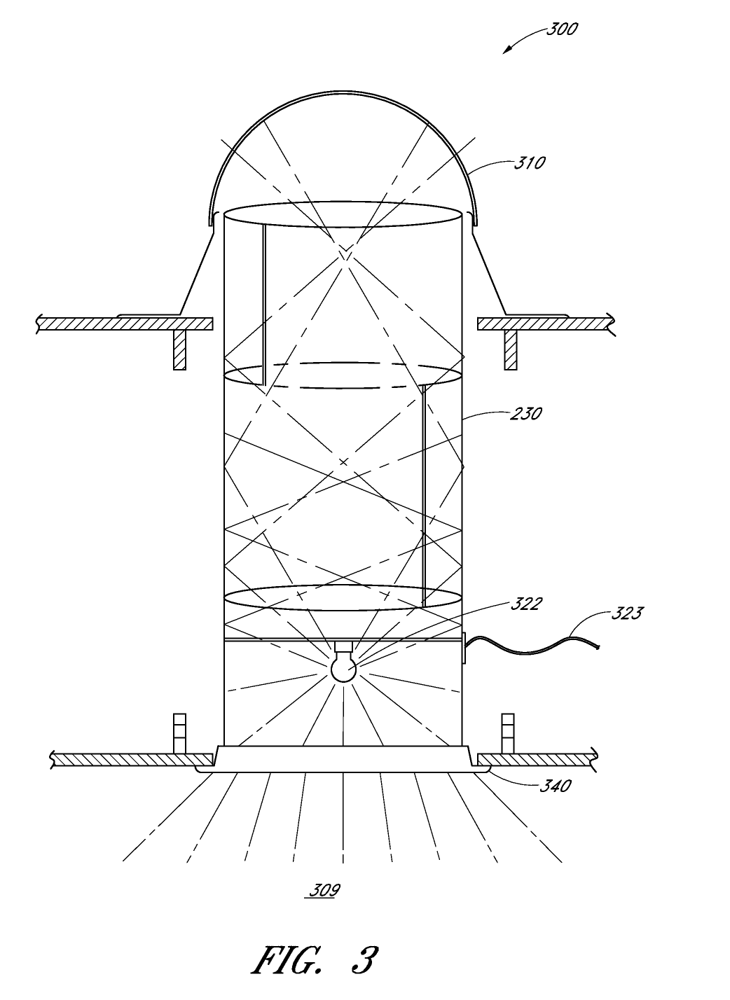

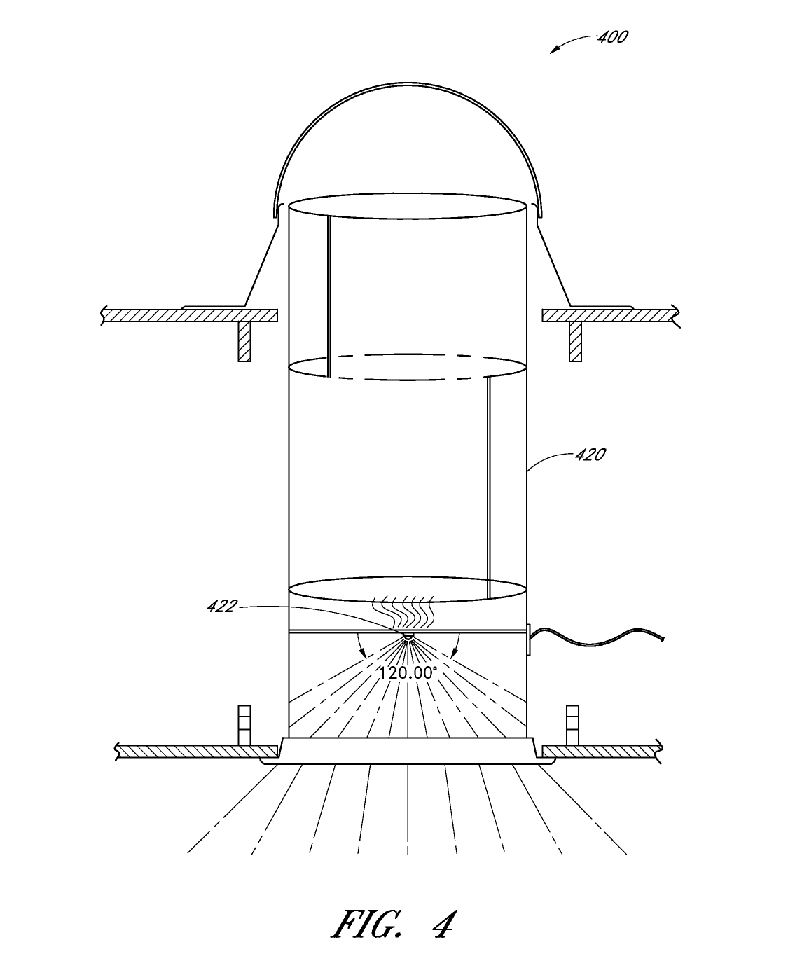

FIG. 4 illustrates a daylighting device 400 incorporating a solid state light source, such as a Light Emitting Diode (“LED”). All references to “LED” or “solid state light” or other particular examples of a light source herein can also apply to other light sources. Such devices produce a relatively large amount of light from a relatively small area. LEDs and other solid state light sources are typically connected to a heat exchanger or heat sink configured to prevent damage to the device or surrounding components due to high temperatures. Therefore, installing one or more LEDs into a daylighting device in a manner similar to that described in connection with FIG. 3 may incur problems similar to those described above. For example, a light fixture, including the metal heat exchanger, will block sunlight coming down the daylighting device. A light fixture can provide a heat exchange area for LEDs that can provide at least about 10 square inches per watt of power (based on, for example, ambient temperatures in the tube of 140° F.). If it is desired that the lumen performance of the LED system matches or exceeds the performance of the conventional light source in an auxiliary lighting system, the amount of heat exchange area required may be greater than or equal to about 100 square inches, greater than or equal to about 200 square inches, or between about 100 square inches and about 200 square inches, based on LED performance. A heat exchanger with a surface area of this size may increase the blockage previously described.

Furthermore, an LED positioned within a daylighting device may be facing down, i.e., towards the diffuser, to prevent light from going up the tube. A typical light spread pattern from an LED can correspond generally with a spherical sector with an apex angle of approximately 120 to approximately 140 degrees. Light propagating down the tube 420 at the same half angles may enter the diffuser at the base of the tube at incident angles ranging from approximately 0 to approximately 70 degrees. A configuration that results in light entering the diffuser at such incident angles can cause optical losses and reduced performance.

Certain embodiments of daylighting devices equipped with conventional lights, including LEDs, can include movable louvers configured to decrease or otherwise control the amount of natural light allowed to pass through the daylighting device. However, such a configuration may be more effective when there is too much natural light, and may obscure the amount of natural light transmitted through the daylighting device when there is not too much natural light. Some embodiments include LEDs placed on a generally annular perimeter ring inside the daylighting device. Such a ring may present a major obstruction to natural light propagating through the daylighting device. For example, a high percentage of the natural light may be reflected around the perimeter of the daylighting device. In some embodiments, a daylighting device is configured to address one or more problems associated with typical LED light spread patterns, which include the problems detailed above.

FIG. 5 illustrates a daylighting device 500 incorporating a solid state light source 522 attached to an interior sidewall of a tube 520 in an orientation in which at least a portion of a light emitting surface of the light source 522 is generally parallel to the interior sidewall of the tube 520. In some embodiments, the light source is attached to an external wall of the tube 520, or to any other component of the daylighting device 500. Furthermore, the light source 522 may be positioned in any desirable configuration. For example, the light source 522 can be connected to a projection extending from the sidewall into the interior of the tube 520. As another example, the light source 522 can be positioned in a recess that extends from the sidewall outward from the interior of the tube 520.

A light control surface 523 can be disposed near or adjacent to the light source 522 and can at least partially surround the light source 522. The light control surface 523 can also be attached to the sidewall of the tube 520 on the side of the light source 522 closest to the cover 510. The light control surface 523 is configured to direct light emanating generally upwardly from the light source 522 in a generally downward direction towards the diffuser 540. Without the light control surface 523, a much larger portion of the directed light would propagate up the tube 520 in the direction of the cover 510 and exit the tube 520 into the exterior environment. Thus, the light control surface 523 can increase luminous intensity at the diffuser 540 while the luminosity of the auxiliary light source 522 is held generally constant. The light control surface 523 can also increase the collimation of light incident on the diffuser 540. In certain instances, the optical efficiency of the diffuser 540 is increased when incident light is more nearly collimated. In certain embodiments, a substantial portion of light emanating from light source 522 will travel at highly oblique angles with respect to the base of the diffuser 540. The efficiency of the diffuser 540 may be lower with respect to light that enters the diffuser at highly oblique angles. Therefore, it may be desirable to bend or align the light from the light source 522 such that it enters the diffuser at more appropriate or desirable angles.

FIG. 6 shows a perspective view of a portion of the tube 520 depicted in FIG. 5 to which a light control surface 523 is attached. The light control surface 523 may also be referred to as a “light control awning” or a “light control film,” and uses of these specific examples are applicable to light control surfaces generally. The tube 520 is generally configured to direct natural light from the cover 510 to the diffuser 540 and to direct auxiliary light from a light source to the diffuser with minimal absorption or loss of visible light.

An interior surface 524 of the tube 520 can be made reflective by any suitable technique, including, for example, electroplating, anodizing, coating, or covering the surface with a reflective film. Reflective films can be highly reflective in at least the visible spectrum and include metallic films, metalized plastic films, multi-layer reflective films, or any other structure that reflects the majority of light in the visible spectrum. In some embodiments, the interior surface 524 is specular. The interior surface 524 may be configured to reflect, transmit, or absorb light outside the visible spectrum in order to achieve certain performance characteristics. For example, the interior surface 524 may be configured to transmit infrared light to improve the thermal characteristics of the tube 520. A material system or layer (not shown) beneath the reflective surface 524 may be configured to strongly absorb infrared light or other radiation that is transmitted through the interior surface 524. An absorptive film, coating, paint, or other material can be used for this purpose.

An exterior surface 526 of the tube 520 may be exposed to a space between the roof of a building 507 and the diffuser. For example, when the diffuser 540 is mounted adjacent to a ceiling 508 of a room 509 to be illuminated, the exterior surface 526 may be exposed to an attic of the building 507 or a pipe chase. The exterior surface 526 may expose the material from which the tube 520 is made or may have a covering that increases performance characteristics of the tube 520. For example, the exterior surface 526 may be covered with a coating or film that aids in the dissipation of heat. In certain embodiments, a high emissivity film is disposed on the exterior surface 526 of the tube 520.

In the embodiment illustrated in FIG. 6, the light control surface 523 extends from the interior surface 524 of the tube 520. The light control surface 523 can be integral with the interior surface 524 or can be a separate material that is connected to the tube 520. Any suitable connection technique can be used, including, for example, fastening, adhering, bonding, friction fitting, welding, gluing, or socketing the light control surface 523 to the tube 520. The light control surface 523 can have a top face 525 that faces the transparent cover 510 and a bottom face 727 that faces the diffuser 540. In some embodiments, the light control surface 523 includes a material of substantially uniform thickness and is curved such that the top face 525 is convex and the bottom face 527 is concave. A tube edge 529 of the light control surface 523 abuts the interior surface 524 of the tube 520 while a peripheral edge 528 of the light control surface 523 extends into the interior volume of the tube 520. The light control surface 523 can be configured such that the amount of natural light incident on the top face 525 is decreased or minimized while the amount of auxiliary light reflected by the bottom face 527 is increased or maximized. The light control surface 523 can be configured such that the luminous intensity at the diffuser 540 is generally increased or maximized, accounting for natural light, auxiliary light, and a combination of natural light and auxiliary light.

The light control surface 523 is configured to direct visible light emanating from the auxiliary light source 522 towards the diffuser 540. The light control surface 523 can be constructed from any suitable material that directs light in this manner, including, for example, a metal, a metalized plastic film, a reflective film, a plastic film with light turning features, an interference coating, or a combination of materials. A reflector above and around the light source can capture light that is directed up the tube and redirect it back down the tube. While the use of a reflector can reduce light loss from the auxiliary lighting fixture, sunlight reflecting down the tube can be at least partially blocked by the reflector when certain materials are used.

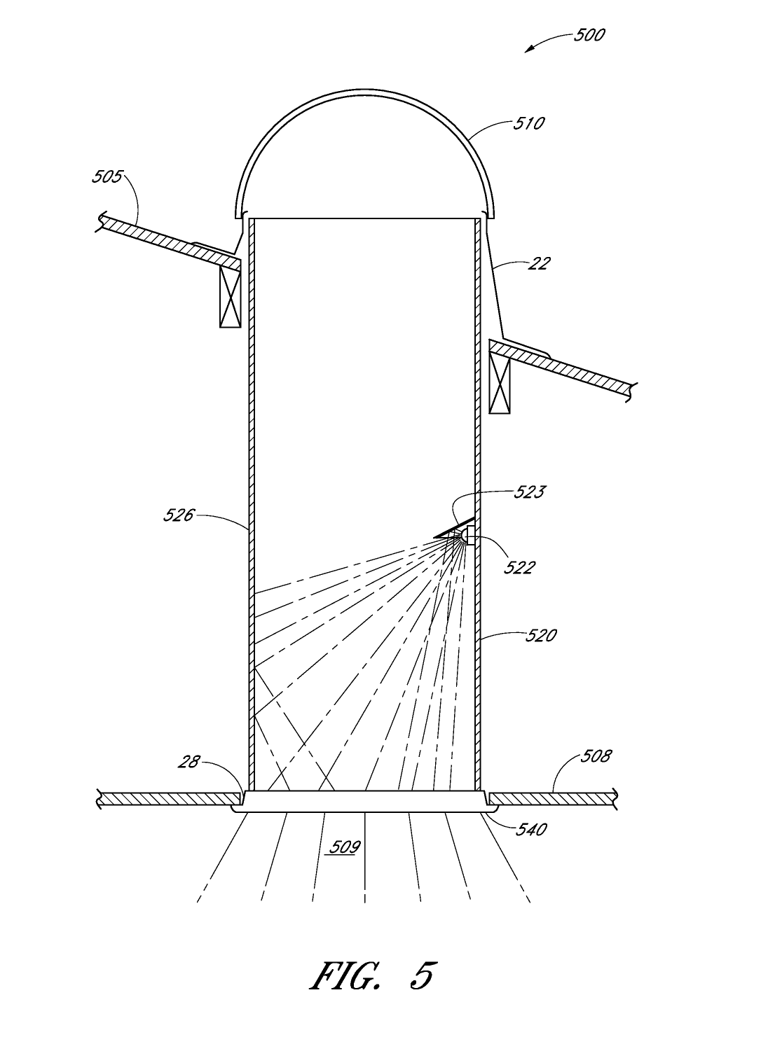

FIG. 7 illustrates an auxiliary light fixture connected to the tube 520. The auxiliary light fixture includes a light source 522 and a prismatic film 723. The light source can include any suitable lighting apparatus (generally referred to herein as a “lamp”) such as, for example, an incandescent light bulb, a fluorescent light bulb, an electromagnetic induction lamp, a high-intensity discharge lamp, a gas discharge lamp, an electric arc lamp, a light-emitting diode (LED), a solid-state lighting apparatus, an electroluminescent apparatus, a chemiluminescent apparatus, a radioluminescent apparatus, a light fidelity lamp, a plurality of lamps, or a combination of lighting apparatus. In some embodiments, a lighting apparatus can be selected to achieve one or more of the following goals: high performance to power required ratio, reduced costs, and compactness. In some embodiments, the light source 522 includes a surface-mount LED such as one available from Cree, Inc. of Durham, N.C. In certain embodiments, the light source 522 includes a consumable element that is easily replaced. For example, the light source 522 can be configured such that a failed lamp can be replaced with a new lamp without substantially disassembling the daylighting device. In some embodiments, the prismatic film 723 is mounted on a hanger (not shown) that removably couples with a bracket (not shown) attached to the sidewall of the tube 520. The hanger and bracket can provide reliable positioning of the prismatic film 723 with respect to the light source 522, which can make installation of the daylighting device substantially easier.

In the example shown in FIG. 7, the light source 522 is flat, thin (e.g., less than or equal to about ⅛″ thick) and occupies an area of approximately 0.75″ by approximately 0.75″. Light sources having many other dimensions and/or geometries can also be used. Light can be emitted from the front surface of the light source 522 in a generally conical emission. In some embodiments, the generally conical light emission can include a vertex angle equal to or greater than or equal to about 60 degrees and/or less than or equal to about 120 degrees, depending on the particular lighting apparatus used. Certain types of lighting apparatus, including LEDs, generate substantial waste heat in addition to the desired output. A heat sink or heat exchanger in thermal communication with the lighting apparatus can be used to remove waste heat. Removing waste heat can improve the efficiency and lifespan of an LED and other types of lighting apparatus. The heat sink can be attached to the back of the lighting apparatus, improving the transfer of heat from the lighting apparatus to the external environment via conduction, convection, and/or radiation.

In some embodiments, the prismatic film 723 illustrated in FIG. 7 can be similar to the light control surface 523 described above, except as further described herein. The film 723 is positioned above and generally around the light source 522. The light control film 723 can be configured to reflect light from the light source 522 generally downward and diminish or minimize the loss of sunlight transported down the tube 520. The configuration of the light control film 723 can encompass one or more of the shape, position, orientation, and curvature of the film 723.

The top face 725 can include turning microstructure that comprises angular prisms that extend the effective length of the film 723. The vertices of the prisms can extend in a direction generally perpendicular to the direction of curvature of the film 723 (e.g., the prisms are substantially linear when the film 723 has one radius of curvature). The sizes of the microstructure and film are exaggerated in the figures to show detail. The bottom face 727 of the film 723 is substantially smooth. In some embodiments, the prismatic film 723 is constructed from a polymeric film such as, for example, 2301 Optical Lighting Film, available from the 3M Company of St. Paul, Minn. An upper edge of the top face 725 can generally slant or taper downwardly, as shown, in the direction away from the top edge 529. In some embodiments, this slanting or tapering can provide increased coverage area around the light source 522 and/or improved downward reflection of the light emitted from the light source 522.

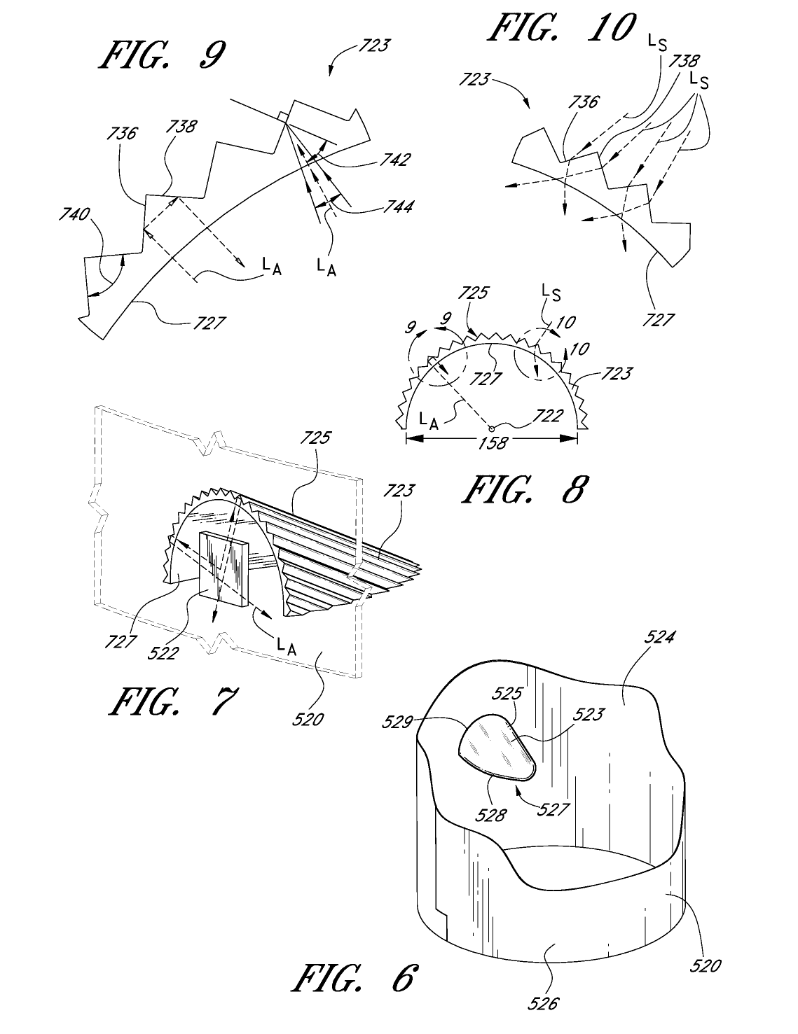

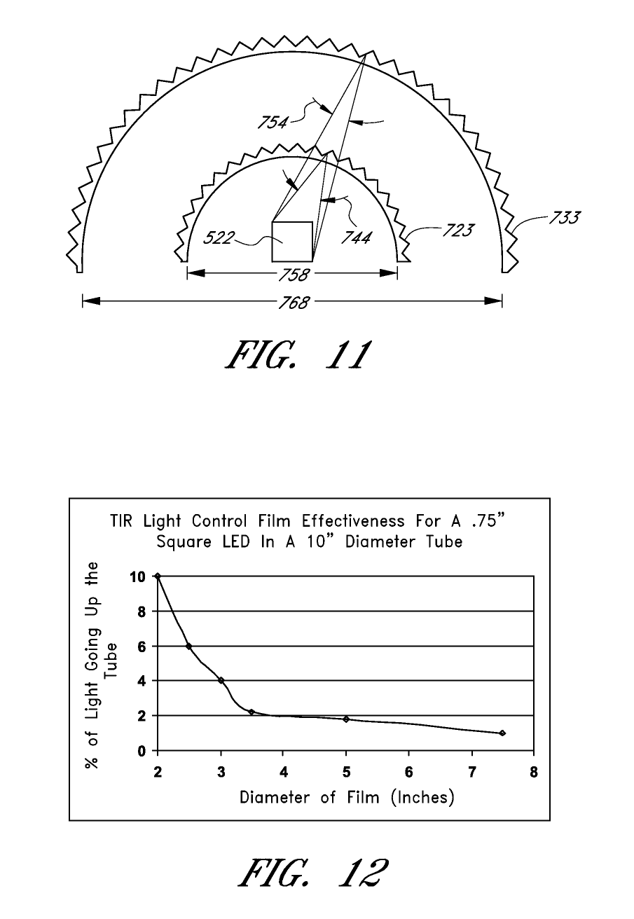

The prismatic film 723 will now be discussed with reference to FIGS. 8-10. Light (L_{A}) from the auxiliary light source 522 can undergo total internal reflection (TIR) when it passes obliquely from a high index medium to a low index medium. In these examples, the high index medium is the prismatic film 723, and the low index medium is air. TIR occurs only at certain angles of incidence bounded by an incident angle called the critical angle 742. Any angle of incidence exceeding the critical angle will cause the incident light to reflect off the interface surface. The reflected angle will be equal to the initial angle of incidence. This critical angle 742 (θ_{Cr}) can be determined for a material interfacing with air using the following formula:

(θ_{Cr})=sin⁻¹(1/n),

where n is the refractive index of the material.

Table C shows examples of critical angles for various transparent materials.

TABLE C

| Material | Refractive Index | Critical Angle |
|---|---|---|
| Teflon | 1.35 | 47.8° |
| Acrylic | 1.49 | 42.2° |
| Glass | 1.52 | 41.1° |
| Polycarbonate | 1.58 | 39.3° |

The prismatic film 723 that exhibits TIR will now be discussed with reference to FIGS. 8-10. Many microscopic 90-degree included angle prisms are molded into the top surface 725 of the film 723. The included angle 740 between the surfaces 736, 738 of the illustrated prism is approximately 90 degrees, while the angle between prisms may be slightly greater than the included angle when the film 723 is curved in the manner shown. The bottom surface 727 of the film is substantially planar or non-structured. Light (L_{A}) that is directed normal to the planar surface 727 reflects off both prism surfaces 736, 738 and reflects back in the direction it came from (for example, not accounting for the third dimension) if the incident angle to the prism surface 736 is greater than the critical angle 742 for the respective material. Because it reflects off both surfaces 736, 738 of the prism, there is a limited range of incident angles 744 that will result in total internal reflection, and the range of incident angles 744 depends on the refractive index of the material. Acrylic, with a critical angle of 42.2 degrees, will TIR light within approximately +/−3 degrees of the normal to the planar surface 727 of the film 723. A higher index material offers a greater range of angles 744 due to the lower critical angle 742. For polycarbonate, the range of angles 744 from normal through which TIR occurs is approximately +/−6 degrees. Thus, higher index materials can provide a greater range of incident angles for TIR to occur.

Daylight (L_{S}) passing through the prismatic side 725 of the film 723 will primarily incur transmission losses due to reflections from the surfaces 727, 725 of the film. In some embodiments, the fraction of light lost due to surface reflections is about 8-10%. Most daylight passes through the film 723 and propagates down the tube 520 to the diffuser 540. When a larger-sized film 723 is used, a greater proportion of daylight L_{S} propagating down the tube 520 is incident on the film 723. Surface reflections are correspondingly greater. In general, a smaller proportion of daylight L_{S} is incident on the film when a film 723 of smaller size is used.

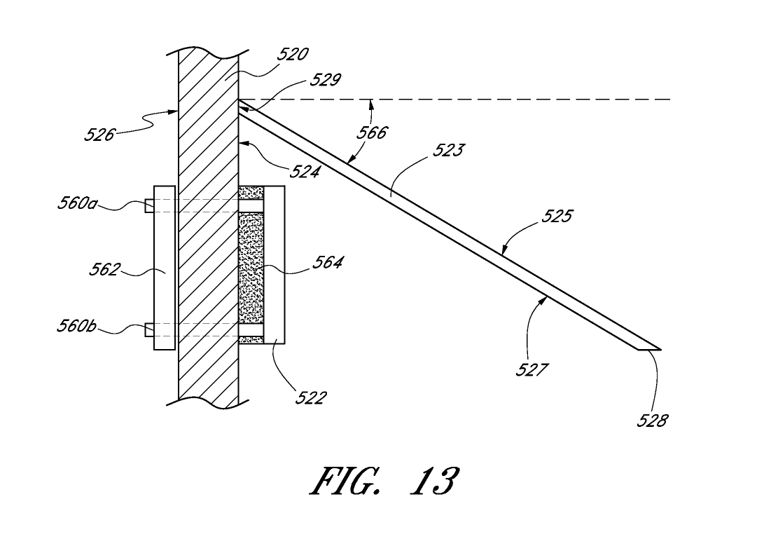

In some embodiments, the prismatic film 723 is flexible and can easily be formed into a variety of shapes. The shape of the film 723 can be selected to increase or maximize the ability of the film 723 to reflect light from the light source 522 towards the diffuser 540. The film 723 can be curved in such a manner that the prisms face out (e.g., on the top surface 725 of the film 723) and the planar side faces in (e.g., on the bottom surface 727 of the film 723). The prisms can extend the length of the film 723. In some embodiments, the film 723 is positioned such that, if a single point source of light is placed at the radius point (e.g., the center point of the diameter) of the film, substantially all of the light rays that strike the prismatic film 723 will be parallel or nearly parallel to the prisms' elongate axis and will TIR off the prisms on the top surface 725. In some embodiments, the light source 522 and the film 723 are configured such that the light rays that strike the prismatic film are normal or nearly normal to the surface 727 when viewed from a two-dimensional perspective, as illustrated in FIG. 11.

A light source 522 having many points of light over its surface, such as, for example, a surface-mount LED, can be used instead of a single point source. Each point in such a light source 522 can have a different path to the film 723. If the light ray is outside of the incident angle range 744 that results in TIR, the light can pass through the film 723 and can be lost up the tube 520. Increasing the diameter 758 of the curved film 723 can reduce the range of incident angles at the film 723 that result from a multi-point source and increase the amount of light that is reflected. Therefore, positioning a curved TIR prismatic film 723 with the radius point at the base of the light source 522 can reflect most light emanating from the light source 522 downward towards the diffuser 540.

Examples of prismatic films having different diameters are illustrated in FIG. 11. A first film 723 having a first diameter 758 is shown. The radius point of the curved film 723 is halfway along the bottom edge of the light source 522. In some embodiments, the film 723 reflects a substantial portion of, substantially all, or all incident light at least at the range 744 of incident angles shown. A second film 733 having a second diameter 768 larger than the first diameter 758 of the first film 723 is also shown. In some embodiments, the second film 733 reflects a substantial portion of, substantially all, or all incident light at least at the second range 754 of incident angles shown. In some embodiments, the range 754 of angles at which incident light is reflected for the second film 733 is narrower than the range of angles 744 for the first film 723, which has a smaller radius of curvature than the second film 733. In certain embodiments, a film 723 of smaller diameter 758 is required to reflect a greater range of incident light when compared to a film 733 of greater diameter 768 if the same amount of reflected light is desired when the same light source is used in each configuration. For example, the material of the film can be selected such that the range of angles at which incident light undergoes TIR is greater than or equal to about the range of angles at which light is received from the auxiliary light source. When the first film 723 and second film 733 comprise the same material or materials, and comprise substantially identical configurations (e.g., prismatic orientation, shape, curvature, size, etc.), the film 733 of greater diameter may reflect more incident light when compared to the film 723 of smaller diameter when used in combination with the same light source. The shape, composition, position, curvature, and size of a prismatic film can be selected to balance improvements in the proportion of light reflected by the surface against the proportion of daylight that is lost due to surface reflections from the film. For example, when a prismatic film with a lower refractive index is used, a larger diameter can be selected to increase reflection of light. A smaller diameter can be selected when a high index film material is used. In certain embodiments, the prismatic film includes a combination of materials having different refractive indices. In certain such embodiments, the prismatic surface of the film can be constructed from a relatively high index material.

The graph shown in FIG. 12 displays the results of an optical analysis of a polycarbonate prismatic film 723 positioned as shown in FIG. 7. Curved films of various diameters were tested in a TDD having a 10″ diameter. A 0.75″ by 0.75″ LED having a light spread of 120 degrees was used as the light source 522. The performance of curved films of various diameters is shown by comparing the proportion of light going up the tube against the diameter of the film. The graph illustrates the relationship between incident angle to the prism and the critical angle tolerance. Using a film of greater diameter can increase the distance from the light source 522 to the film 723, can reduce the incident angle to the surface of the film 723, and can increase the proportion of light reflected towards the diffuser 540. When the proportion of light directed towards the diffuser 540 increases, the proportion of light going up the tube is decreased.

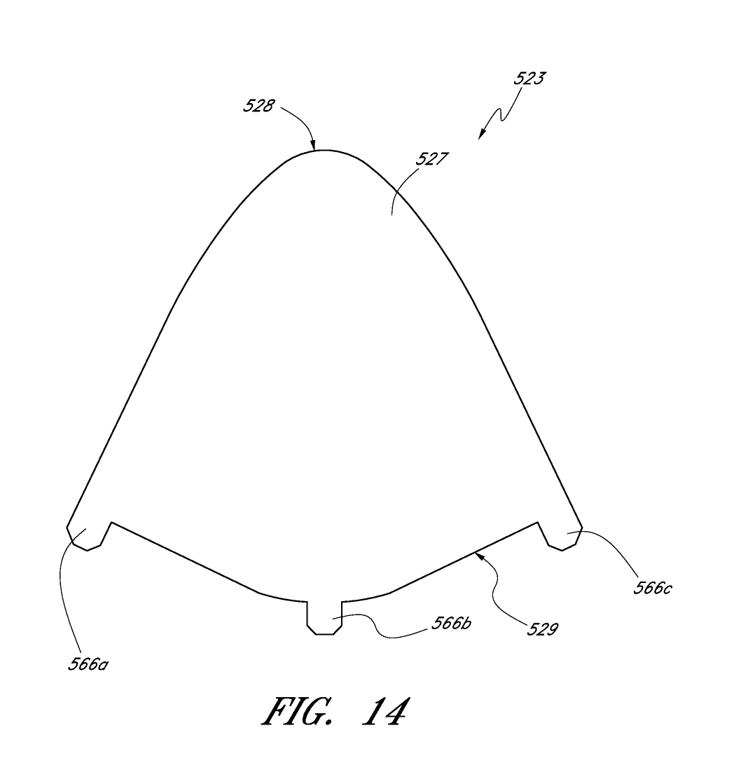

If a light control surface 523 were placed at a 90 degree angle to the light source 522—in other words, if the surface 523 were mounted perpendicular to the tube wall 520 and the angle from horizontal were zero—the surface 523 would generally need to extend across the entire tube to capture and redirect all light emanating from the light source 522. A surface 523 in this orientation would occupy a large portion of the tube's cross section. Referring now to FIG. 13, a cross-sectional view of a light control surface 523 and a light source 522 connected to the sidewall of a tube 520 is shown. Tilting the curved surface 523 down to an angle 566 at which the reflected light from the surface 523 generally does not reflect a significant amount of light back onto the light source 522 can reduce the amount of light control material required, reduce the distance that the surface 523 extends into the tube 520, and cause the light to be more vertically reflected down the tube. In some embodiments, the angle 566 between the surface 523 and horizontal is greater than or equal to about 20 degrees and/or less than or equal to about 45 degrees, or greater than or equal to about 10 degrees and/or less than or equal to about 30 degrees.

The tilt 566 from horizontal of the curved surface 523 can be selected based on, for example, the range of angles at which light is emitted from the light source 522, the size and shape of the tube 520, the size and shape of the light control surface 523, and the size and shape of the light source 522. For the illustrated example, the half-angle spread of the light source 522 is 60 degrees. Thus, if the light control surface 523 were sloped down 30 degrees from horizontal, at least some of the light would be reflected back into the light source 522. In some embodiments, reducing the angle 566 to about 20 degrees can cause light to be reflected past the LED. Further, extending the base perimeter 528 of the lens to the same horizontal plane as the base of the light source 522 allows upwardly directed light to be captured and reflected down the tube 520.

With further reference to FIG. 13, thermal heat exchange grease 564 can be applied between the light source 522 and the wall of the tube 520 in order to facilitate removal of waste heat. The tube 520 can provide a structure for holding the light source 522 in place. For example, fasteners 560a-560b can be used to connect the light source 522 to the sidewall of the tube 520. The light source 522 can be connected to the sidewall in other ways, such as, for example, with an adhesive. The fasteners 560a-560b can be inserted through a back plate 562, a nut, or another suitable structure disposed on the outside surface 526 of the tube 520 in order to strengthen the connection between the light source 522 and the sidewall. In some embodiments, the light source 522 is tightly engaged with the inside surface 524 of the tube 520 in order to increase thermal conductivity between the light source 522 and the tube 520. The conductivity and thickness of the tube 520 can facilitate conduction of heat away from the light source 522 to the large area of the tube 520, which can act as a heat sink for the light source 522. The tube 520 radiates the heat outside and inside of the tube 520 based on the emissivity of the exterior surface 526 and the interior surface 524 of the tube 520. The light source 522 can be connected to a power source (not shown) via wires and/or electrical connectors.

In some embodiments, the placement of the light source 522 on or near a sidewall of the tube 520 can minimize or decrease blockage of sunlight traveling down the tube when compared to a placement of the light source 522 in the center of the tube 520 or facing downward. The placement can also provide an economical structure for removing heat and supporting the light source 522. In some embodiments, the front light emitting surface of the light source 522 faces the inside area of the tube and is in an orientation generally parallel to the longitudinal axis of the tube. In certain other embodiments, the light source 522 is tilted at an angle with respect to the axis of the tube. For example, the light source 522 can be tilted toward the diffuser or face the diffuser. In some embodiments, without a light control surface, up to 50% of light output by the light source 522 can go up the tube 520 and be wasted, while the remainder would go down to the diffuser 540 at various incident angles.

The light control surface 523 will now be discussed with reference to FIGS. 6, 13, and 14. In some embodiments, the light control surface 523 is generally curved when positioned within the tube 520, but can be cut from or molded in a generally flat sheet and then bent or folded into a desired shape. An example of an unfolded top view of the light control surface 523 is shown in FIG. 14. The light control surface 523 can be connected to the tube 520 by adhering the top edge 529 of the surface 523 to the tube 520, by friction fitting the surface 523 into a slot (not shown) in the tube 520, by adhering or friction fitting one or more tabs 566a-566c extending from the top edge 529 of the surface 523 to the tube 520, or by any other suitable technique. In some embodiments, the tabs 566a-566c are positioned at least at the boundaries between the top edge 529 and the base perimeter 528 and at a middle point along the top edge 529. As illustrated, the light control surface 523 can be positioned near the light source 522. In some embodiments, the light control surface 523 can generally surround an upper region of the light source 522 as shown.

As installed in the tube 520, the light control surface 523 can be shaped, curved, positioned and/or bent in a manner that enhances certain performance characteristics of the surface 523. For example, a connection between the surface 523 and the tube 520 can be used to create a bend in a flexible material (such as, for example, a polymeric film) such that the surface 523 generally has the form of a section of a half-cylinder around the light source 522 as shown in FIG. 6. While the surface 523 near or at its top edge 529 may have a substantially semi-circular or substantially half-cylindrical curvature, the curvature of the surface 523, including the radius of curvature, may vary as the surface 523 extends into the interior of the tube 520. Variation in the curvature of the surface 523 may depend on, for example, the amount of flex in the surface 523, the stiffness of the surface 523, the size of the surface 523, the shape of the surface 523, other factors, or a combination of factors. The surface 523 can be positioned near the light source 522 as shown in FIG. 13 and surround the light source as shown in FIG. 6. The surface 523 can also be positioned such that the light fixture is substantially symmetrical about a vertical plane of symmetry. In some embodiments, the tabs 566a-566c shown in FIG. 14 are inserted into corresponding slots or openings (not shown) in the wall of the tube 520, with friction, an adhesive, or another type of connection holding the position and curvature of the surface 523 substantially fixed with respect to the tube 520. The surface 523 can be any suitable shape, including, for example, the shape shown in FIG. 14. In certain embodiments, the surface 523 has a curved top edge 529 that conforms substantially to the tube 520 and a base perimeter 528 that assumes a substantially planar arch when the surface 523 is installed in the tube 520. In some embodiments, the plane in which the base perimeter 528 exists is substantially perpendicular to the sidewall of the tube 520.

In some embodiments, the light control surface 523 is connected to a rigid, or partially rigid, member, such as a hanger. The rigid member may conform to the shape of the top edge 529, and may be substantially “U”-shaped. The rigid member may be connected to the light control surface by any suitable connection mechanism. For example, the rigid member may include a recess, such as an elongated recess that runs along the perimeter of the rigid member, into which the light control surface can be nested or secured. In certain embodiments, the rigid member includes a hook that hooks onto a structural feature of the tube 520, such as a fixture secured to the wall of the tube 520, or a slot in the wall of the tube 520. In such embodiments, the weight of the rigid member and/or light control surface may secure the light control surface 523 against the insidewall 524 of the tube 520.

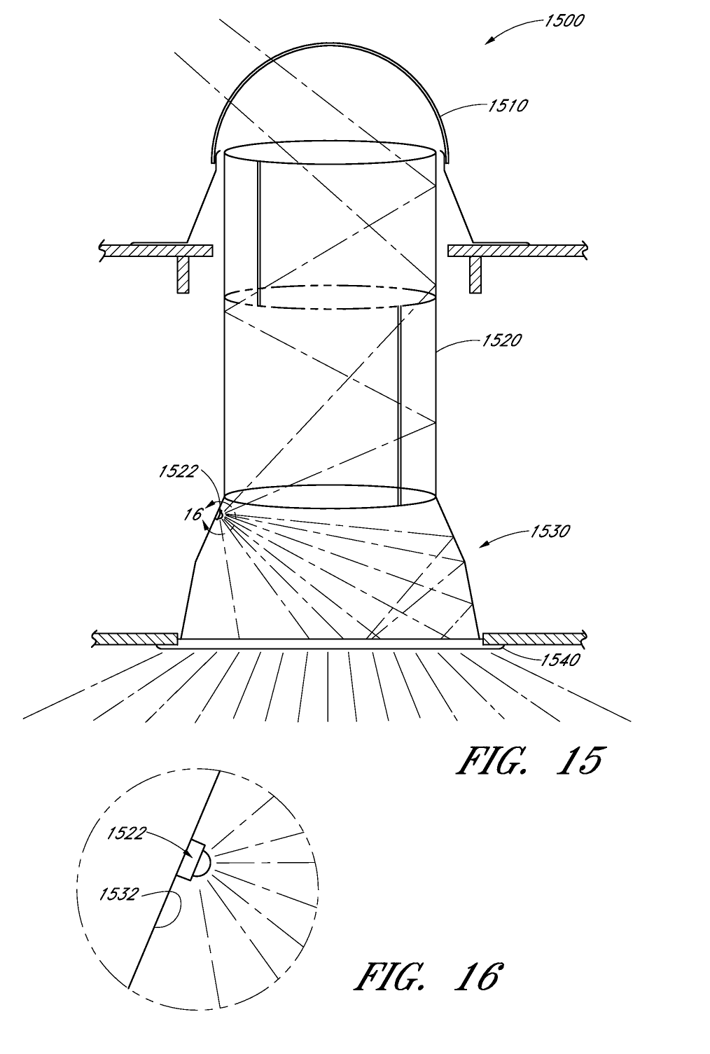

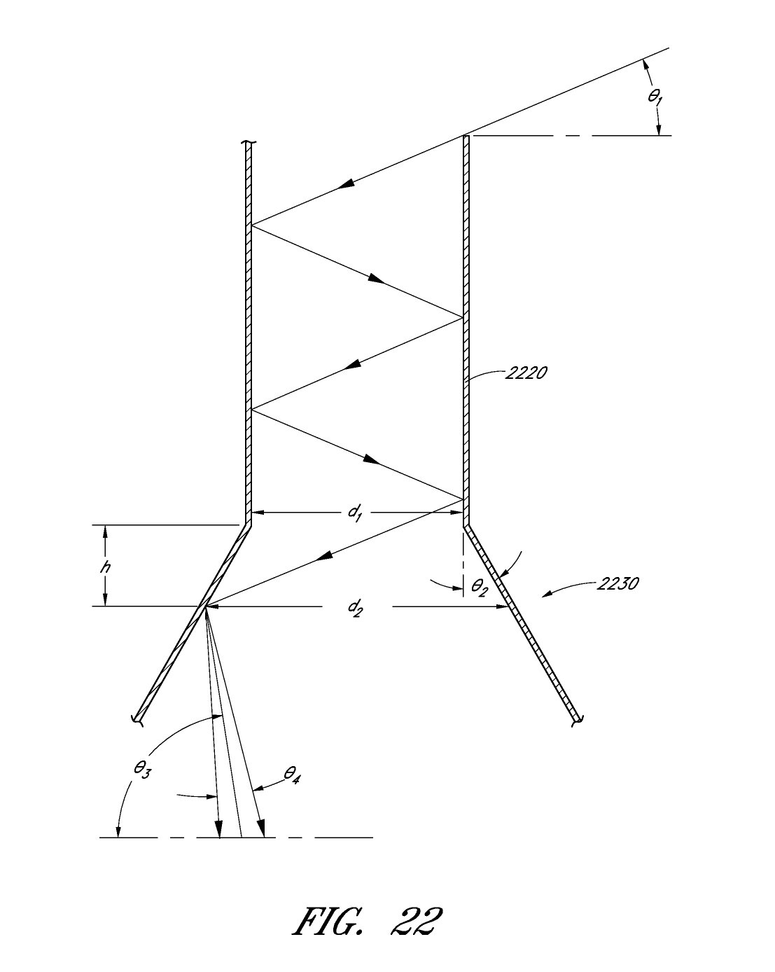

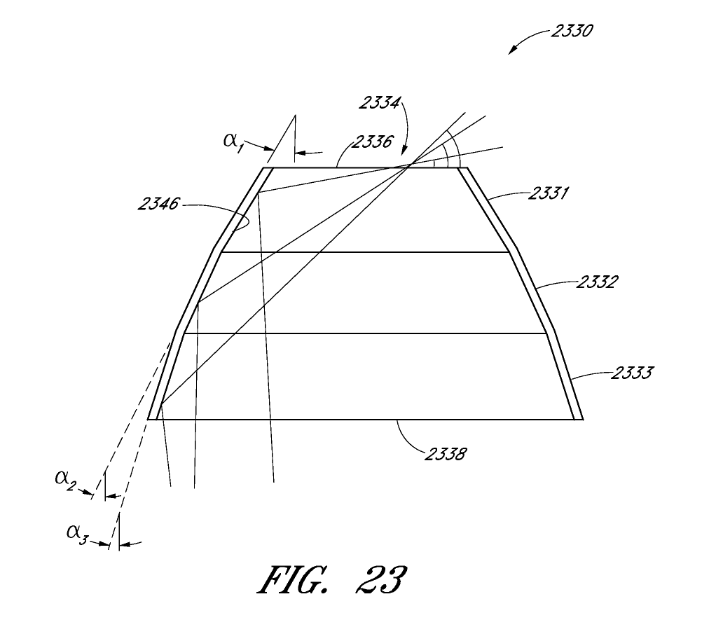

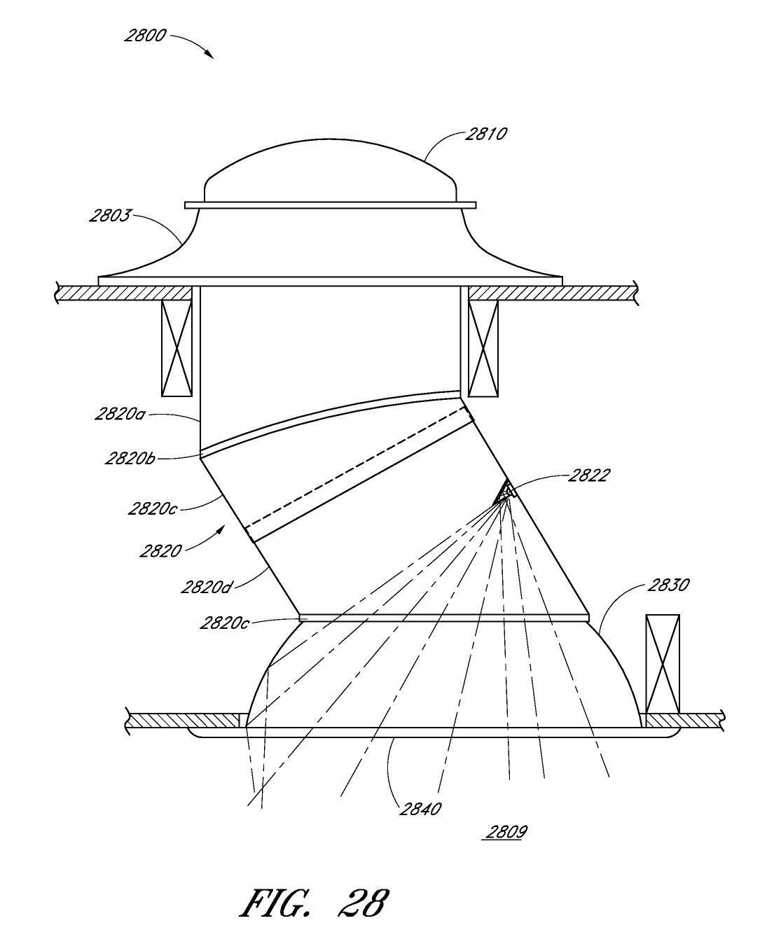

FIG. 15 illustrates an embodiment of a daylighting device 1500 incorporating an auxiliary light source 1522 and a collimator 1530. Light source 1522 and collimator 1530 represent embodiments of lighting system 122 and collimator 130 of FIG. 1, respectively. The collimator 1530 serves to generally align rays of light propagating through the daylighting device 1500 so that the light reaches the diffuser 1540 at greater angles with respect to the base of the diffuser 1540 than it would otherwise without a collimator. Some of the effects associated with configuring a daylighting device in accordance with the embodiment of FIG. 15 may be reduced blockage of natural light transported down the tube due to any obstructions, and increased performance of natural light or artificial light exiting the base diffuser 1540. The daylighting device depicted in FIG. 15 includes a light source 1522 positioned within a multi-segment, or multi-stage, collimator 1530. In some embodiments, the collimator 1530 is a single-stage collimator. Collimators, including multi-segment collimators are discussed in more detail below in connection with FIGS. 22-27.

In certain embodiments, sunlight entering the tube will have a solar altitude (angle from the horizon) that will remain substantially the same as it reflects down the tube when the tube sides are vertical and parallel. Installation of a collimator, such as a flared out reflective tube, at or near the base of the tube with the diffuser attached to the base may substantially reduce the incident angle of light to the diffuser, which may increase the diffuser optical efficiency and the system performance.

Test results have demonstrated the increased performance of a daylighting device that is equipped with a collimator with respect to dispersion of sunlight entering the tube of the device through an aperture exposed to sunlight. The test results, which are provided in TABLE D, were taken in connection with a tube installed vertically with the top opening of the tube being horizontal. The test results provided in TABLE D were with an in-house goniophotometer that measured the total lumen output of the base diffuser and the total sunlight available to the tube aperture. These two values provide the visible transmission efficiency of the complete tube. The tube was tested in two embodiments: with a multistage collimator at the base of the tube and the diffuser on the collimator base; and without the collimator and the same diffuser at the base of the tube. As shown in TABLE D, five different solar angles were tested.

TABLE D

| Solar | | | Increase in |
|---|---|---|---|
| Altitude | Straight | Collimated | Performance |
| (Degrees) | Tube | Tube | (Col. - Str./Str.) |
| 20 | 53.1% | 61.9% | 17% |
| 30 | 45.3% | 56.0% | 24% |
| 40 | 41.2% | 48.1% | 17% |
| 50 | 40.6% | 48.4% | 19% |
| 60 | 38.1% | 41.2% | 8% |

As the test results demonstrate, addition of a collimator apparatus to a daylighting device may increase efficiency of sunlight dispersion by at least about 8%, in some cases between about 8% and about 24%, or possibly more, depending on the configuration of the device.

FIG. 16 provides a close-up view of the light source 1522 depicted in FIG. 15. The light source 1522 depicted in FIGS. 15 and 16 is connected to an inner wall 1532 of the collimator 1530. In certain embodiments, the light source 1522 is connected, either directly or indirectly, to an exterior wall, or contained within the wall or other region of the collimator 1530.

While much of the light emanating from light source 1522 travels down the daylighting device 1500 toward the diffuser 1540, ultimately exiting the daylighting device through the diffuser 1540, as illustrated in FIG. 15, some amount of light may travel up the daylighting device 1500 and out through the cover 1510. Cover 1510 and diffuser 1540 represent embodiments of the light-collecting unit 110 and diffuser 140 described above with respect to FIG. 1. The amount of light that travels up the daylighting device 1500 and exits through the cover 1510 may depend on the position of the light source 1522 within the collimator 1530. For example, in certain embodiments, light emanating from a light source positioned near the diffuser may propagate through the diffuser at a higher percentage than light emanating from a light source positioned farther from the diffuser. In certain embodiments, the converse may be true, depending on particular characteristics of the diffuser, some of which are discussed further with respect to FIGS. 22-27.

Certain embodiments include one or more auxiliary light sources positioned within, or adjacent to, the tube 1520 in place of, or in addition to, one or more light sources positioned within, or adjacent to, the collimator 1530.

Certain embodiments, such as that depicted in FIG. 17, comprise a light source 1722 that is connected to a tube 1720 or collimator 1730 interior wall in proximity to one or more prismatic awnings 1723, as described above with respect to FIGS. 5-14. The awning 1723 serves to prevent light from traveling up the tube 1720 by reflecting the light downward towards the diffuser 1740. In certain embodiments, the light is reflected generally downwardly by the awning 1723 in directions ranging from vertical to approximately 80 degrees from vertical. Large variance or range in the angle of light propagating down the tube can cause optical losses or inefficiencies in the base diffuser, or, with respect to embodiments which do not include a diffuser, at least a portion of the light exiting the tube may not be usable due to the acuteness of the exiting angle. The use of a reflective awning 1723 within, or in combination with, a collimator 1730 can assist in redirecting otherwise undesirable or unusable light to a smaller range of incident angles to the diffuser 1740 at its base. Test results comparing a system with an LED and an awning on a vertical tube without a collimator to a system incorporating an LED and an awning positioned within a collimator with three different diffusers are listed in Table E below:

TABLE E

| | Frosted Glass | Radial Lens | Pyramid Prism |
|---|---|---|---|
| Tube Format | Diffuser | Diffuser | Diffuser |
| Vertical Tube | 391 lumens | 478 lumens | 563 lumens |
| Collimator Tube | 639 lumens | 588 lumens | 710 lumens |
| % Increase | 63% | 23% | 26% |

The test results above demonstrate a substantial increase in performance of a system in which an auxiliary light source is positioned within a collimator, as shown in FIG. 17, over a system without such features. This substantially improved performance may be due to the characteristics of light emanating from a light source disposed on a sidewall of a tube in a daylighting device. For example, the light source can be disposed in a generally vertical orientation. In certain embodiments, a significant portion of light emanating from an auxiliary light source disposed on a sidewall of a tube reflects within the tube at highly oblique angles with respect to the base of the tube and/or diffuser. Therefore, the presence of a collimating structure configured to bend light reflecting at highly oblique angles can significantly increase the amount of light that enters the diffuser at an angle appropriate or desirable for the diffuser.

In addition to increased performance, it may be desirable for the spread of light exiting the diffuser to be contained within a generally conical zone directly below the diffuser with an included angle of approximately 120 degrees, between about 110 degrees and about 130 degrees, or between about 100 degrees and about 140 degrees. The test results detailed in Table F demonstrate the performance of the two systems tested above with respect to the amount of light contained within a desirable generally conical zone of space located below the diffuser:

TABLE F

| | Frosted Glass | Radial Lens | Pyramid Prism |
|---|---|---|---|
| Tube Format | Diffuser | Diffuser | Diffuser |
| Vertical Tube | 300 lumens | 344 lumens | 406 lumens |
| Collimator Tube | 498 lumens | 462 lumens | 548 lumens |
| % Increase | 66% | 34% | 35% |

These test results demonstrate the superior performance of the system depicted in FIG. 17 relative to a system not including a collimator. As demonstrated by the results in Table F, not only does the inclusion of a collimating structure substantially improve the general performance of artificial light, but the performance with respect to light transmitted within a desirable generally conical zone is even more substantially improved.

The system efficacy and natural light blockage of the system of FIG. 17 were further tested, the results of which are listed in Table G and Table H:

TABLE G

| | | | System |
|---|---|---|---|
| | Source | Tested | Efficacy |
| | Rated | Performance | (Tested/ |
| Light Source | (Lumens) | (Lumens) | Source) |
| 4-CREE X-PG | 240 lumens/each, | 645 lumens | 67% |
| 4,000K R2 LEDs | total of 960 lumens | | |

The system efficacy of daylighting apparatuses designed in accordance with embodiments disclosed herein may vary depending on specific components and configurations thereof. For example, a daylighting apparatus incorporating a light-aligning, or collimating, structure and one or more auxiliary light sources may be configured to achieve greater than or equal to about 40% efficacy. That is, greater than or equal to about 40% of the total light emanating from the one or more auxiliary light sources can exit the daylighting apparatus through the diffuser. Certain embodiments may achieve system efficacy greater than or equal to about 60%, 65%, 70%, or higher.

TABLE H

| Sunlight | Sunlight | PerCent |
|---|---|---|
| Performance With | Performance | Blockage of |
| 4-LEDs and | Without | Sunlight @ |
| Their Awnings | LEDs and their | Solar Altitude |
| in a Collimator | Awnings | of 50 deg. |
| 1,964 lumens | 2,031 lumens | 3% |

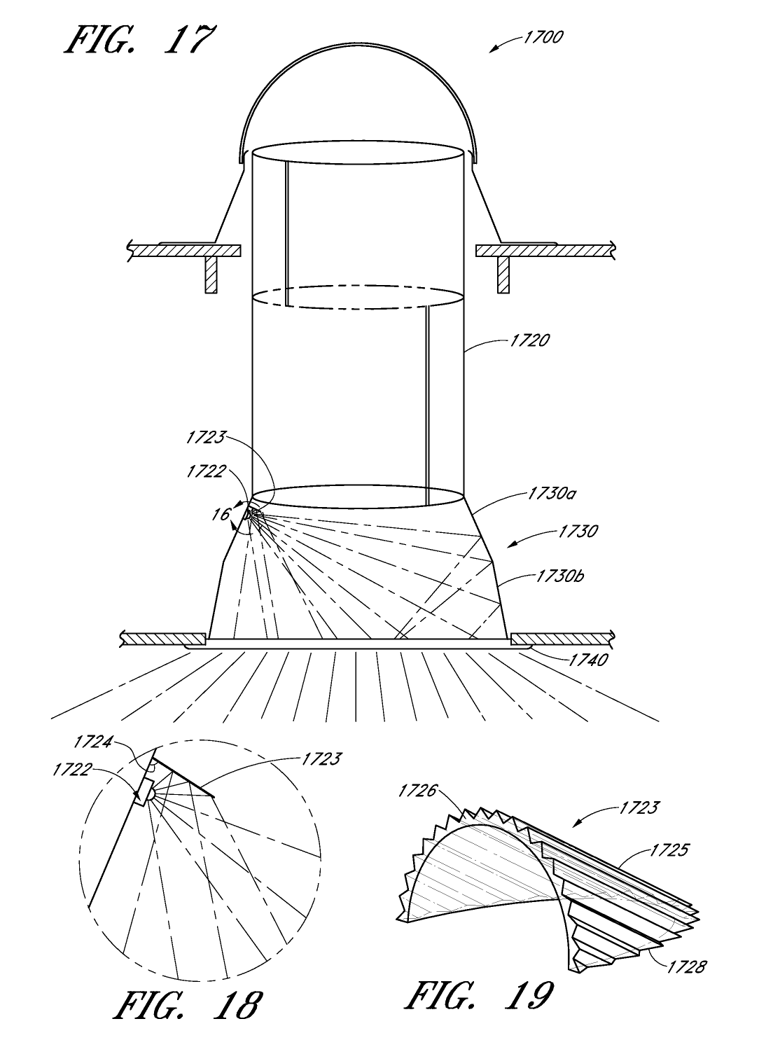

According to the above results, the system efficacy may increase by greater than or equal to 72% and the blockage of natural light may decrease by greater than or equal to 70% by incorporating an LED with an awning within a collimator, as shown in FIG. 17. The awning 1723 of FIG. 17 is illustrated in more detail in FIG. 18. The angle 1724 between the center of the awning 1724 and the wall of the daylighting device 1700 may be selected such that the awning 1723 directs a desirable amount of light from the light source 1722 generally downwardly towards the diffuser 1740, while allowing little or no light to clear the awning 1723 at an angle that would cause such light to travel back up the tube 1720. The awning 1723 may be positioned, or configured, such that the base 1728 of the awning lies on a plane that intersects the center, bottom, or other portion of the light source 1722. The length and/or size of the awning 1723 may be chosen to optimize the amount of light reflected by the awning, while not causing an undesirable amount of natural light to reflect back up the tube 1720 as a result of surface reflection on the top face 1725 of the awning. In certain embodiments in which the surface 1726 of the awning in closest proximity to the sidewall of the daylighting apparatus 1700 generally forms a half-circle, or similar shape, around the light source 1722, the light source 1722 is disposed around a radius point of the half-circle or similar shape.

The collimator 1730 depicted in FIG. 17 is a multi-stage collimator, having two stages, 1730a and 1730b. Multi-stage collimators are discussed in more detail below with reference to FIGS. 23-27.

In certain embodiments, as shown in FIG. 17, the collimator 1730 is positioned above the ceiling 1708 of a structure. Therefore, the collimator, in certain embodiments, is not configured to protrude into the interior room into which light is presented via the diffuser 1740. As shown, the top of the collimator 1730 may mate or adjoin with the base of the tube 1720. The width of the top of the collimator may be substantially equal to the width of the base of the tube 1720. Furthermore, the collimator 1730 may have a frustro-conical shape such that the width of the collimator flares out moving away from the base of the tube. In such embodiments, the width of the collimator over a majority of the collimator's height may be greater than the width of the tube 1720 at its base. In certain embodiments, no portion of the collimator extends into the tube, nor does any portion of the tube extend into the collimator.

In certain embodiments, light is incident on the collimator 1730 in a wide range of angles while light exiting the collimator is substantially collimated, or, at a minimum, more collimated or substantially more collimated than light entering the collimator. In certain embodiments, light passing through the collimator 1730 towards a target area of a room also passes through the diffuser 1740. The diffuser may be configured such that light exiting the diffuser is distributed within the interior of a room such that the light is incident on wall and floor surfaces directly, but only indirectly, if at all, on the ceiling surface 1708, possibly via secondary reflections within the room.

In certain embodiments, light propagating through the daylighting device 1700 contacts the collimator 1730 on its interior surface, and is bent generally towards the center of the collimator. While the interior surface of the collimator 1730 is reflective, the exterior surface may not be highly reflective. In certain embodiments, the outer surface of the collimator 1730 receives substantially none of the light propagating within the daylighting device 1700. That is, only one of the interior and exterior surfaces of the collimator is exposed to light propagating within the daylighting device 1700.

In certain embodiments, the interior reflective surface of the collimator 1730 is configured such that light propagating through the daylighting device 1700 is incident only once on the interior surface of the collimator.

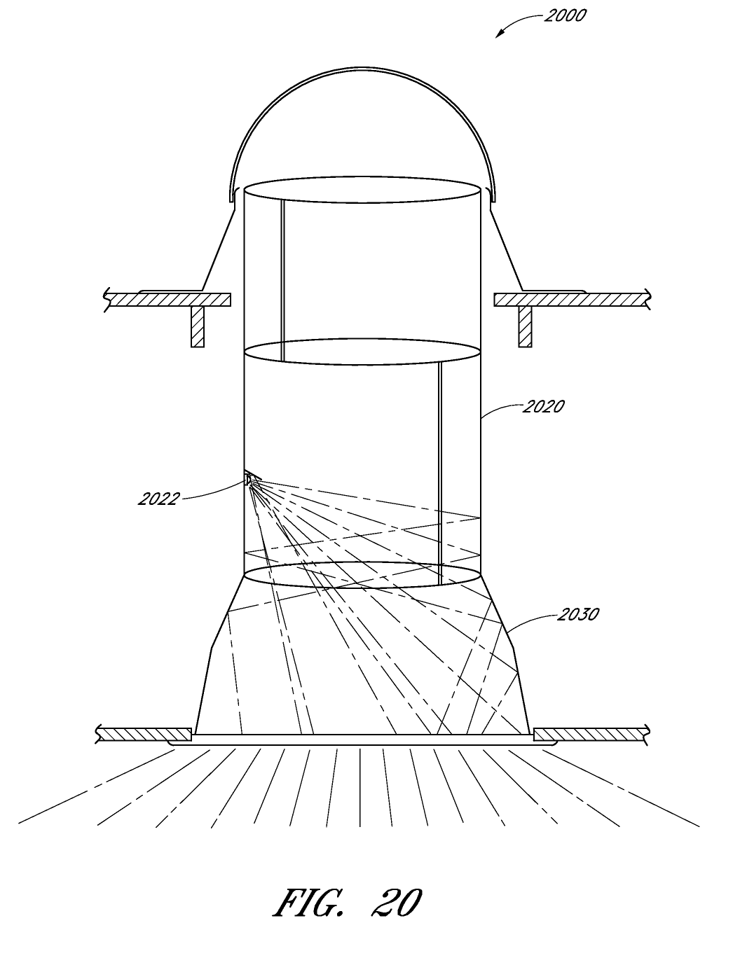

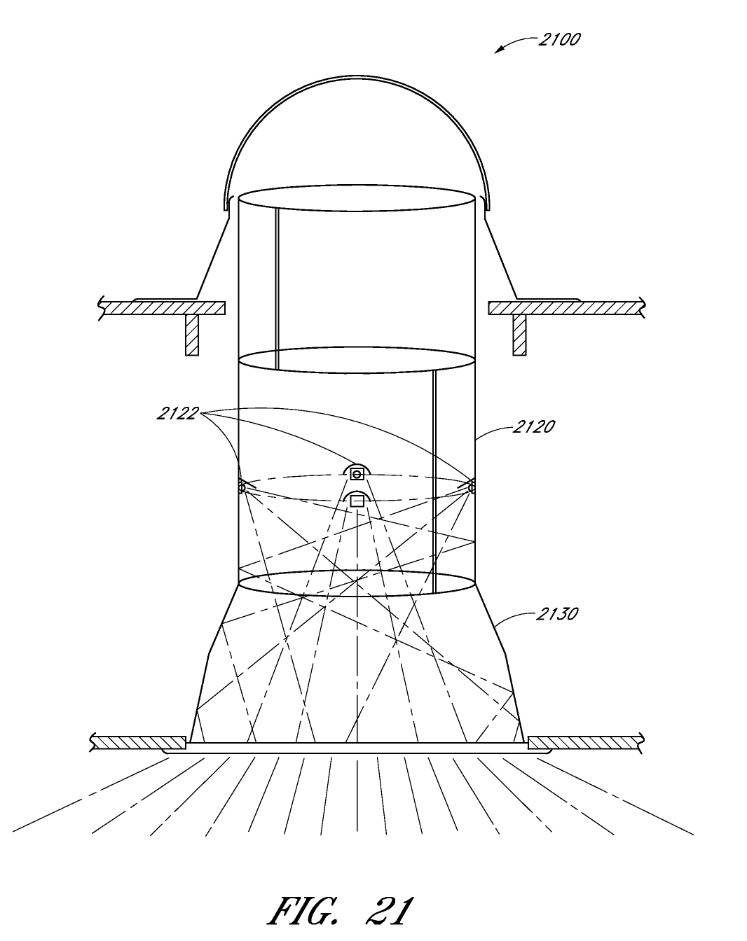

FIG. 20 shows an embodiment of a daylighting device including an auxiliary light source 2022 and a collimator 2030, in which the auxiliary light source 2022 is positioned within the tube 2020. Certain of the features of daylighting device 2000 represent embodiments of corresponding features of daylighting device 100 illustrated in FIG. 1, and described above with reference thereto. The embodiment of FIG. 20 includes a prismatic awning located in proximity to the light source 2022.

The embodiment depicted in FIG. 21 includes a plurality of auxiliary light sources 2122 in a general ring configuration along a circumference of the tube 2120. Embodiments may include any number of light sources. For example, one or more rings of LEDs, in groups of four, eight, or any other number, may be positioned around a circumference of the tube. In certain embodiments, one or more light sources are positioned within collimator 2130, either in addition to, or in place of, light sources positioned within the tube 2120. The present disclosure contemplates any possible number or arrangement of light sources connected, either directly or indirectly, to daylighting device 2100.

FIG. 22 provides a cross-sectional view of a daylighting device including a collimator portion 2230. The collimator 2230 may reflect light generally in the direction of a diffuser or opening in the daylighting device. The angle θ₁ refers to the solar altitude, or angle of incidence of the sun with respect to a horizontal plane. The angle θ₂ refers to the angle at which the collimator portion 2230 flares out with respect to the vertical wall of the tube 2220. The angle θ₃ refers to the alignment angle of light reflecting off of the wall of the collimator portion 2230, with respect to a horizontal plane. The following equations represent the relationship between these angles:

θ₂=((θ₃)−(θ₁))/2 and θ₃=(2)(θ₂)+(θ₁)

In certain embodiments, the collimator portion 2230 can realign natural light or light from an auxiliary light source while diminishing or minimizing reflective material and space of the collimator 2230. The dimensions of the collimator 2230 may be determined using the following equations:

d₁=Diameter of the collimator at the top or light entrance;

d₂=Diameter of collimator where light is reflected based on light entering the collimator from the top diameter at a specific θ₁ and light reflected at a specific θ₃;

h=Height of the collimator at the related d₂; then:

d₂=(2)((d₁)(tan θ₁))/((1/tan θ₂)−(tan θ₁))+(d₁);

h=(d₂−d₁)/(2 tan θ₂) where θ₂ is the angle of collimator portion relative to the vertical axis.

Each consecutive segment diameter and height can be determined from the previous segments values as follows:

N is new value, P is previous value and AP is ½ the increase in diameter from d₁ to d₂P. Thus, using the example in TABLE I below to determine h N for the collimator@a θ₁ of 35 degrees, AP would be (13.64−10.0)/2=1.82″.

h N=((d₁+AP)(tan θ₁N)−(h P)(tan θ₁N)(tan θ₂N))/1−(tan θ₁N)(tan θ₂N)

d₂N=d₂P+(2)(h N−h P)(tan θ₂N)

In some embodiments, light undergoes only one reflection in the collimator portion 2230 to provide the required alignment angle.

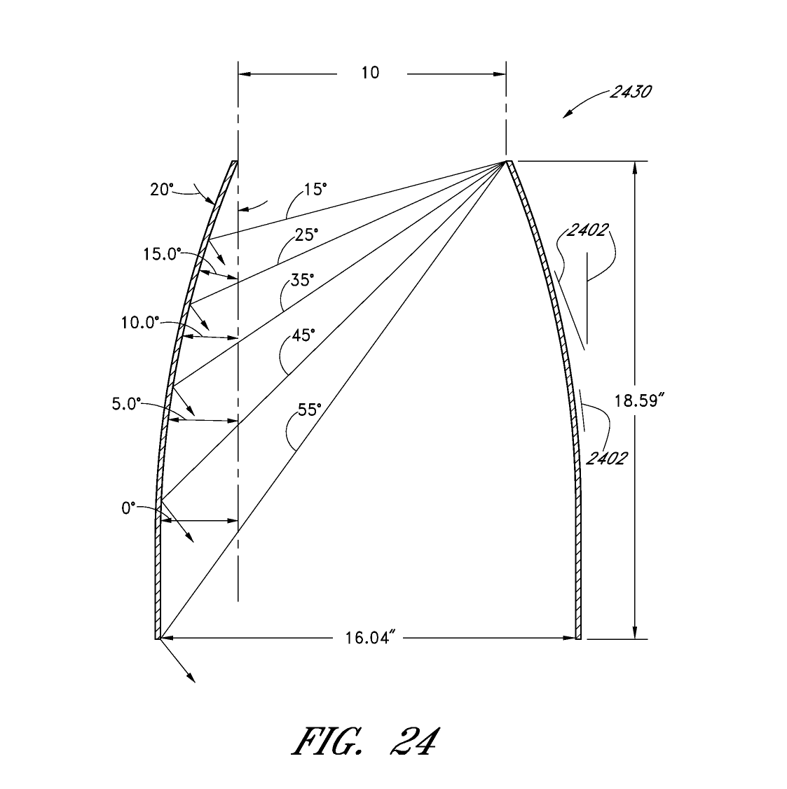

With the above in mind, for a collimator region that provides an alignment angle (θ₃, the axis of the light spread, θ₄, as shown) greater than or equal to 55 degrees with an input range of light (θ₁) from 15 degrees up to 55 degrees, the following dimensions may be used. The below table is in increments of ten degrees/five segments of (θ₁). For this example, the top of the collimator region opening is assumed to be ten inches in diameter. An example multiple stage collimator is shown in FIG. 24.

TABLE I

| θ₁ | θ₂ | Tube Dia. | Tube height |
|---|---|---|---|
| 15° | 20° | 12.16″ | 2.96″ |
| 25 | 15 | 13.64 | 5.51 |
| 35 | 10 | 14.91 | 8.72 |
| 45 | 5 | 15.81 | 12.90 |
| 55 | 0 | 16.04 | 18.59 |

In certain embodiments, the collimator 2230 is a multiple stage collimator. Multiple stage collimators are described further with respect to FIG. 23. A multiple stage collimator may result in smaller dimensions than a comparable single stage that achieves the same results. For example, a single stage collimator may need to be approximately one third-longer in axial dimension and six percent greater in diameter than a multi-stage collimator to perform at an equivalent level to the multi-stage collimator.

The collimator 2230 may include a non-specular inside surface with controlled light spread, θ₄. Such a surface may reduce glare and non-uniform illumination associated with using a specular surface. Use of a non-specular surface may provide a controlled spread of light, such as less than or equal to approximately ten degrees, which may eliminate certain drawbacks mentioned above, without unduly affecting the alignment angle. In certain embodiments, the inside surface of the collimator 2230 is specular.

As natural light entering the tube 2220 when the sun is at a high angle is relatively closer to perpendicular with respect to a horizontal plane, the benefits of collimator region 2230 may be comparatively small.

FIG. 23 depicts a cross-sectional view of a multiple stage collimator. In certain embodiments, the collimator 2330 has a generally axially aligned series of collimator segments 2331, 2332, 2333. In the embodiment depicted in FIG. 23, each successive collimator segment from top to bottom is less outwardly-flared than the one immediately above it such that the collimator tapers inwardly in a downward direction. As light propagates down a daylighting device to which a collimator such as that depicted in FIG. 23 is connected near its base, light rays that enter the collimator 2230 at highly acute angles with respect to a horizontal plane are more likely to strike the inner wall of the collimator 2230 at its first segment 2331 than are rays entering at less acute angles. This is due to the fact that light rays propagating in a generally vertically oriented daylighting device at more acute angles with respect to a horizontal axis do not traverse as great a distance along the vertical axis between contacts with the sidewall of the daylighting device as rays that propagate at less acute angles. Therefore, rays reflecting within the daylighting device at highly acute angles are less likely to penetrate the collimator deeper than the first segment of the collimator 2331 without contacting the first segment 2331 than are rays reflecting at less acute angles. Because it may be desirable for the collimator to reflect light such that the reflected light exiting the daylighting device more closely approximates a right angle with respect to the base of the collimator 2338, or the daylighting device, than it would absent the collimator, the segments of the collimator 2330 may be designed to “bend” more acutely propagating light to a greater degree towards the base of the collimator than less acutely propagating light. The configuration of the embodiment of FIG. 23 generally accomplishes this with segments that are progressively less flared-out along a vertical axis.

In certain embodiments, the multi-stage collimator 2330 changes the angle of low angle sunlight to a consistent high angle and, when a non-specular inside surface is used, with a minimum of glare. By maintaining relatively high angles to the diffuser/glazing independent of the solar altitude, consistent glazing efficiencies are maintained throughout the day. In some embodiments, a daylighting device incorporating a collimator does not comprise a diffuser, providing similarities in appearance and/or effect to a recessed lighting fixture. Present principles may also provide a consistent angular controllight source for any light directing pendent or other optical element placed under the collimator 2330.

With further reference to FIG. 23, the collimator 2330 has a top region 2334 and a bottom region 2338. The top region 2334 of the collimator may be contiguously engaged to a lower intermediate portion of a daylighting device tube configured in accordance with embodiments disclosed herein. The bottom region 2338 of the collimator may be covered by a diffuser assembly as also described herein. In certain embodiments, the bottom region 2338 of the collimator is left open or closed by way of a non-diffusing bottom covering, and/or lacks a diffuser assembly engaged therewith.

Also as stated above, the collimator 2330 has multiple collimating segments. In some embodiments the collimating segments are generally frusto-conical. In some embodiments they may assume other collimating shapes, e.g., generally frusto-pyramidal. Thus, there may be a first frustum-shaped collimating segment 2331 defining a first collimating angle α₁ with respect to an axis of the collimator and a second generally frustum-shaped collimating segment 2332 connected to the segment 2331 and defining a second collimating angle α₂ that is less than the first collimating angle with respect to an axis of the collimator. Furthermore, in some embodiments there may also be a third generally frustum-shaped collimating segment 2333 connected to the segment 2332 and defining a third collimating angle α₃ that is less than the first and second collimating angles. The collimating angles associated with collimator segments configured in accordance with embodiments disclosed herein may comprise any suitable or desirable angles, and need not resemble angles or relationships between angles depicted in FIG. 23 or any other figure or embodiment described above. Furthermore, collimator embodiments disclosed herein may comprise any number of segments. For example, collimators incorporated in daylighting device structures may comprise 2, 3, 4, 5, 6, or more distinct segments, or may have only a single segment.

With further reference to FIG. 23, the collimating segment 2331 is more flared than the collimating segment 2332. Similarly, in the depicted embodiment, the collimating segment 2332 is more flared than the third collimating segment 2333. In embodiments comprising more than three collimating segments, each consecutive collimating segment may be more flared than the one below it.

The inside surface 2346 of the collimator 2330 can be non-specular in certain embodiments. The non-specular inside surface may be established by a structured surface in a metal substrate, reflective film or adhesive on a film. It can be in the form of dimples, corrugated patterns or other shapes that provide a controlled spread of light of, e.g., less than or equal to about ten degrees. Using a non-specular surface may provide a controlled light spread as desired, e.g., a spread of light that is within the range of about plus or minus five degrees from the central reflected ray of light. Non-specular surfaces may be incorporated in single-stage, as well as multi-stage collimators, such as, for example, in the collimator depicted in FIG. 23. The multi-stage collimator described above may advantageously require less axial space than a single stage collimator yielding equivalent performance.

The collimator depicted in FIG. 24 does not comprise visibly discrete, finite collimator segments. In certain embodiments, the collimator 2430A has more than three stages and indeed may have a number of stages that approach the limit of infinity, i.e., each stage effectively has little or no thickness in the longitudinal dimension. Accordingly, in some embodiments, the collimator 2430 may have an approximately continuously curved shape in the longitudinal dimension as shown, in which tangents 2401, 2402 to the surface with respect to the longitudinal axis 2404 of the collimator progressively define steeper angles from the collimator's light entry to the light exit. The reflection angles and collimator dimensions shown in FIG. 24 are exemplary only and not limiting.

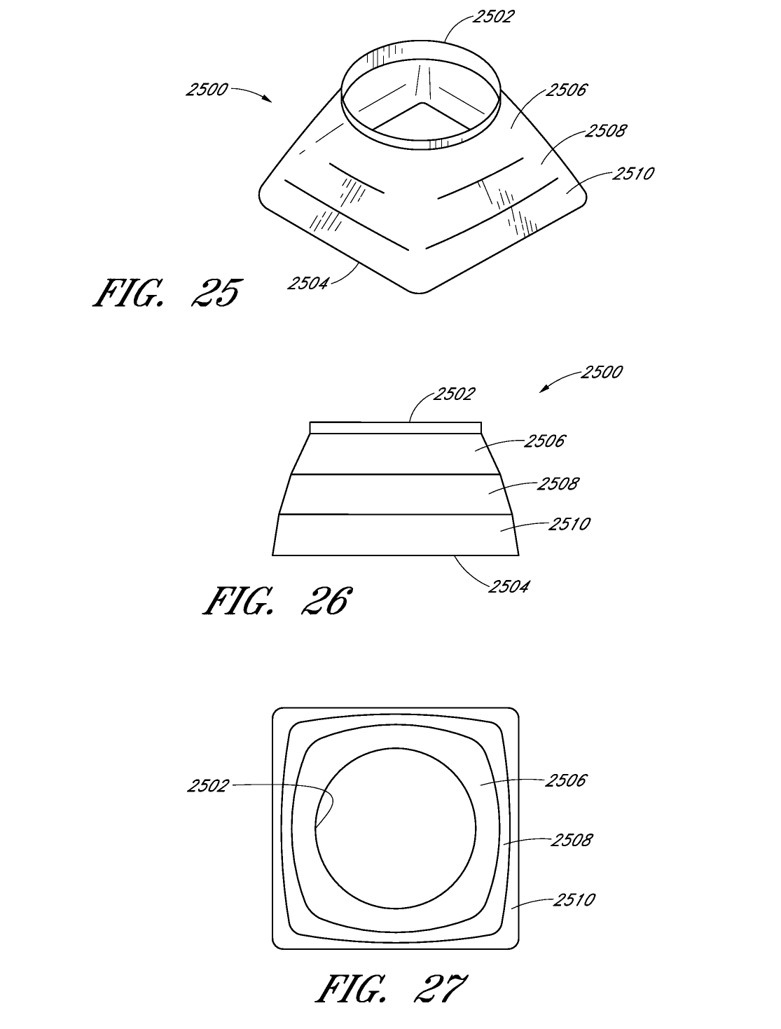

A collimator assembly 2500 is shown in FIGS. 25-27 that has, from a round top opening 2502 to a rectilinear bottom opening 2504, multiple collimator stages 2506, 2508, 2510, with the stages 2506-2510 being successively less flared than the next upper stage. Thus, the assembly 2500 in FIGS. 25-27 is similar to the collimators discussed above with the exception of the round to square configuration from top to bottom as shown. To achieve the round-to-square configuration, in which the top opening 2502 may mate with the bottom of a cylindrical daylighting device tube while the bottom opening 2504 may mate with a rectilinear diffuser or ceiling opening, the stages 2506-2510 transition progressively in the axial dimension from mostly round (the top stage 2506) to predominantly rectilinear (bottom stage 2510) as shown.

FIG. 28 illustrates an embodiment of a daylighting device assembly including an auxiliary light source and a collimator. The daylighting device 2800 includes a tube or tube region 2820 which serves as a light guide for light propagating through the daylighting device 2800. In some embodiments, the tube 2820 comprises an internally reflective hollow metal shaft assembly, generally. The cross-section of the tube 2820 can be generally cylindrical, generally rectangular, generally triangular, or any other suitable shape. In some embodiments, the tube 2820 directs light that enters the daylighting device 2800 generally downwardly to a light diffuser assembly 2840 that is disposed in an interior room 2809 of a structure.

The tube 2820 may be made of a metal such as an alloy of aluminum or steel, or may be made of plastic or other appropriate material. The interior of the tube 2820 is rendered reflective by means of, e.g., electroplating, anodizing, metalized plastic film coating, or other suitable means.

In some embodiments, the tube 2820 is a single shaft. However, as shown in FIG. 28, if desired, the tube 2820 may include multiple segments, one or more of which are internally reflective in accordance with present principles. Specifically, the 2820 can include an upper region 2820a that is engaged with a flashing 2803, or other member of the daylighting device assembly 2800. The tube may further include an upper intermediate region 2820c that is contiguous to the upper region 2820a that may be angled relative thereto at an elbow 2820b. Moreover, the tube 2820 can include a lower intermediate region 2820d. Such region 2820d may be slidably engaged with the upper intermediate region 2820c for absorbing thermal stresses in the tube 2820. A collimator-like lower region 2830 can be contiguous to the lower intermediate region 2820d and join the lower intermediate region 2820d at an elbow 2820e, with the bottom of the lower collimator region 2830 being covered by the diffuser assembly 2840. The elbow 2820e may be angled as appropriate for the structure such that the tube 2820 connects a roof-mounted cover 2810 to the ceiling-mounted diffuser assembly 2840. It is to be understood that, where appropriate, certain joints between shafts can be mechanically fastened and/or covered with tape.

The embodiment depicted in FIG. 28 further comprises an auxiliary light source 2822, such as an LED, positioned within the tube 2820. While the illustrated embodiment shows the light source 2822 positioned within lower intermediate region 2820d, it should be understood that one or more auxiliary light sources may be positioned within any of the regions of the daylighting device 2800, such as within the collimator region 2830, and the lower intermediate region need not contain a light source.

Certain embodiments described herein may provide various direct and/or indirect economic and environmental benefits, such as reduction in energy consumption, reduction in greenhouse gas emissions, and/or other benefits, when compared to certain alternative lighting systems. For example, electrical power consumption, lighting performance and heat generation were calculated or measured with respect to various lighting systems, the results of which are produced below in Table J. The conventional lighting system listed in Table J is based on an example commercial application having an interior ceiling height of 8 to 10 feet and using 2-foot-by-2-foot luminaries with 2 T8 fluorescent bulbs. As described in the table, such a light source may provide approximately 3,050 lumens of light and require approximately 65 watts of power. The performance of the conventional lighting system was compared to that of a TDD incorporating a 14-20″ collimator structure, radial diffuser, and cylinder-dome-shaped light collector. Additional measurements and calculations were taken using auxiliary LEDs positioned within the collimator structure. The LED lighting system included 8 CREE 5000K XML LEDs operating at 6.4 watts each, which would produce, after optical losses, approximately 3,240 lumens. When sunlight is available. This example of a TDD system may produce 3,500 lumens +/−400 lumens through the day/year during relatively clear weather. In diffuse conditions, it may produce about 1,000 lumens. The solar heat gain coefficient for this system was measured at about 0.21 due to the dome and the IR heat transfer tubing, among possibly other causes. A comparison of these numbers and associated parameters is presented in Table J:

TABLE J

| | | | | Electrical | |
|---|---|---|---|---|---|
| | | | | Power | |
| | | Electrical | | Required | |
| | | Power | | For Cooling | Total |
| | Luminaire | For | Heat | w/EER | Power |
| Lighting | Performance | Lights | Gain | 9.65 | Used |
| System Design | (Lumens) | (Watts) | (Btu/Hr) | (Watts) | (Watts) |
| Conventional | 3,050 | 65 | 225 | 24 | 89 |
| 2 × 2 Luminaire | | | | | |
| w/2-T8 | | | | | |
| Fluorescent | | | | | |
| Bulbs and K12 | | | | | |
| Diffuser | | | | | |
| 14″ Cylinder- | 3,500 | — | 58 | 6 | 6 |
| Dome w/14-20″ | | | | | |
| Collimator and | | | | | |
| Radial Diffuser | | | | | |
| 8-CREE 5000K | 3,240 | 51 | 174 | 18 | 69 |
| XML LEDs in | | | | | |
| the Collimator | | | | | |

As demonstrated in Table J, during clear or near clear sunlight during the summer, use of a TDD as described above in place of a conventional lighting system may provide a reduction in electrical consumption of approximately 83 watts (89−6) per fixture. Based on an estimated illumination coverage of approximately 80 ft² of floor area per fixture, a single 10,000 ft² facility may achieve a total energy savings of approximately 830 KW. Such a reduction in energy consumption may provide economic savings, a reduction in greenhouse gas emissions, and a reduced need for electricity, which is mostly generated by burning fossil fuels such as coal and natural gas. Furthermore, due to the relatively high efficiency of LED lights, similar benefits may be experienced during non-sunlight periods.

At least some of the embodiments disclosed herein may provide one or more advantages over existing lighting systems. For example, certain embodiments effectively allow a TDD to increase or maximize the lighting potential from at least two light sources—daylight and an auxiliary light source. As another example, some embodiments provide techniques for directing light from at least two light sources in a way that decreases or minimizes wasted light. At least some of these benefits can be achieved at least in part by placing an auxiliary light source into a tubular daylighting device without substantially obscuring daylight propagating down the tube. At least some of these benefits can be achieved at least in part by using a light control surface that transmits daylight while capturing the upwardly propagating light from an auxiliary light source. At least some of these benefits can be achieved at least in part by shaping and tilting the light control surface in relation to the light source.

Certain embodiments may provide additional benefits, including reducing the incident angle at the diffuser of light propagating from the auxiliary light source, which can result in the diffuser operating with higher optical efficiency. Another benefit can include extra spreading of the light reflected from the light control surface when compared to direct light from a light source (for example, from a light source facing down the tube towards the diffuser).

Discussion of the various embodiments disclosed herein has generally followed the embodiments illustrated in the figures. However, it is contemplated that the particular features, structures, or characteristics of any embodiments discussed herein may be combined in any suitable manner in one or more separate embodiments not expressly illustrated or described. For example, it is understood that an auxiliary light fixture can include multiple light sources, lamps, and/or light control surfaces. It is further understood that the auxiliary lighting fixtures disclosed herein may be used in at least some daylighting systems and/or other lighting installations besides TDDs.

It should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Moreover, any components, features, or steps illustrated and/or described in a particular embodiment herein can be applied to or used with any other embodiment(s). Thus, it is intended that the scope of the inventions herein disclosed should not be limited by the particular embodiments described above, but should be determined only by a fair reading of the claims that follow.

What is claimed is:

1. A daylighting apparatus for providing natural light to the interior of a building, the apparatus comprising:
a tube having a sidewall with a reflective interior surface, the tube configured to receive daylight through a transparent cover disposed near a top end of the tube and to direct the daylight towards a bottom end of the tube;
a diffuser configured to be positioned inside of the building and configured to receive the daylight directed towards the bottom end of the tube;
an auxiliary lighting system comprising a light source configured to provide illumination to at least a portion of the interior of the daylighting apparatus, the light source positioned such that light that is emitted by the light source propagates such that the at least a portion of the light is incident on a surface other than the diffuser before propagating to the diffuser; and
a light-aligning apparatus having one or more wall segments with an exterior surface and a reflective interior surface configured to receive at least a portion of the light propagating through the tube and to turn the at least a portion of the light in order to increase an included angle between the path of propagation of the at least a portion of the light and a reference plane parallel to a base of the diffuser;
wherein the light-aligning apparatus has a top edge disposed substantially near the bottom end of the tube and a base edge disposed farther away from the tube than the top edge, wherein a width of the light-aligning apparatus at its top edge is greater than or equal to a width of the tube at the bottom end of the tube.

2. The daylighting apparatus of claim 1, wherein the auxiliary lighting system is connected to the sidewall of the tube.

3. The daylighting apparatus of claim 1, wherein the auxiliary lighting system is connected to the light-aligning apparatus.

4. The daylighting apparatus of claim 1, wherein auxiliary lighting system comprises a plurality of light sources.

5. The daylighting apparatus of claim 4, wherein the plurality of light sources are arranged along a generally planar section of the tube.

6. The daylighting apparatus of claim 4, wherein the plurality of light sources are arranged along a generally planar section of the light-aligning apparatus.

7. The daylighting apparatus of claim 4, wherein at least one of the plurality of light sources is connected to the sidewall of the tube and at least one of the plurality of light sources is connected to at least one of the one or more wall segments of the light-aligning apparatus.

8. The daylighting apparatus of claim 1, wherein the light source is a light-emitting diode.

9. The daylighting apparatus of claim 1, further comprising a light control surface positioned in proximity to the auxiliary lighting system and configured to reflect light from the light source towards the diffuser.

10. The daylighting apparatus of claim 1, wherein the one or more wall segments comprises a plurality of wall segments configured to form a collimator with at least one collimating angle.

11. The daylighting apparatus of claim 10, wherein the plurality of wall segments are configured to form a collimator with two or more collimating angles.

12. The daylighting apparatus of claim 1, wherein the tube comprises a first segment and a second segment, wherein the first and second segments are removably connected to each other.

13. The daylighting apparatus of claim 1, wherein greater than or equal to about 50% of the light emitted by the auxiliary lighting system exits the daylighting apparatus through the diffuser.

14. The daylighting apparatus of claim 1, wherein greater than or equal to about 65% of the light emitted by the auxiliary lighting system exits the daylighting apparatus through the diffuser.

15. The daylighting apparatus of claim 1, wherein the exterior surface of the light-aligning apparatus is not exposed to light propagating within the daylighting apparatus.

16. The daylighting apparatus of claim 1, wherein the base edge of the light-aligning apparatus is disposed above the diffuser.

17. The daylighting apparatus of claim 1, wherein the top edge of the light-aligning apparatus is disposed below the base edge of the tube.

18. The daylighting apparatus of claim 1, wherein the light-aligning apparatus has a width located at a longitudinal center of the light-aligning apparatus that is greater than the width of the tube at its base edge.

19. The daylighting apparatus of claim 1, wherein the top edge of the light-aligning apparatus is joined to the base edge of the tube.

20. The daylighting apparatus of claim 1, wherein a cross-sectional shape of the light-aligning apparatus at its top edge is substantially the same as a cross-sectional shape of the tube at its base edge.

21. A method of providing light to an interior of a building, the method comprising:
permitting daylight to pass from a transparent cover through a tube to a diffuser inside of the building;
emitting artificial light from an auxiliary light source into an interior region of the tube; and
collimating, with a light-aligning apparatus, at least a portion of the daylight and at least a portion of the artificial light simultaneously;
wherein a width of the light-aligning apparatus at a top edge of the light-aligning apparatus is greater than or equal to a width of the tube at a bottom end of the tube.

22. A method of manufacturing a daylighting apparatus, the method comprising:
connecting a transparent cover configured to receive daylight to a top region of a tube having a sidewall with a reflective interior surface;
connecting a top region of a light-aligning apparatus having an exterior surface and a reflective interior surface to a base region of the tube, wherein the base region of the tube is disposed farther away from the transparent cover than the top region of the tube;
connecting a diffuser to a base region of the light-aligning apparatus, wherein the base region of the light-aligning apparatus is located farther away from the base region of the tube than the top region of the light-aligning apparatus; and
fixing an auxiliary lighting system comprising a light source to the daylighting apparatus, the light source configured to provide illumination to at least a portion of the interior of the daylighting apparatus by emitting a generally conical emission of light such that at least a portion of the light emitted by the auxiliary lighting system is incident on a surface other than the diffuser before propagating to the diffuser;
wherein the light-aligning apparatus is configured to reflect light propagating through the tube that is incident on the interior surface of the light-aligning apparatus, thereby increasing an included angle between the path of propagation of the reflected light and a reference plane parallel to a base of the diffuser lies, and
wherein a width of the light aligning apparatus at its top region is greater than or equal to a width of the tube at its base region.

23. A method of manufacturing a daylighting apparatus, the method comprising:
providing a tube having a sidewall with a reflective interior surface;
providing a transparent cover configured to receive daylight and to be connected to a top region of the tube;
providing a light-aligning apparatus having a reflective interior surface and a top region configured to be connected to a base region of the tube, wherein the base region of the tube is disposed farther away from the transparent cover than the top region of the tube;
providing a diffuser configured to be connected to the light-aligning apparatus; and
providing an auxiliary lighting system comprising a light source configured to be fixed to the daylighting apparatus, the light source further configured to provide illumination to at least a portion of the interior of the daylighting apparatus by emitting a generally conical emission of light such that at least a portion of the light emitted by the auxiliary lighting system is incident on a surface other than the diffuser before propagating to the diffuser;
wherein the light-aligning apparatus is configured to reflect light propagating through the tube that is incident on the interior surface of the light-aligning apparatus, thereby increasing an included angle between the path of propagation of the reflected light and a reference plane parallel to a base of the diffuser; and
wherein the top region of the light-aligning apparatus is disposed substantially near the base region of the tube, wherein a width of the light-aligning apparatus at its top region is greater than or equal to a width of the tube at its base region.
